(19) United States
(12) Patent Application Publication
(10) Pub. No.: US 2025/0317850 A1
(43) Pub. Date: Oct. 9, 2025

(54) MANAGING DISCONTINUOUS COVERAGE AND POWER SAVING MODE IN NTN USING TIMERS

(71) Applicant: Google LLC, MOUNTAIN VIEW, CA (US)

(72) Inventors: Ming-Hung TAO, Taoyuan City (TW); Chih-Hsiang WU, Taoyuan City (TW)

(21) Appl. No.: 18/873,596

(22) PCT Filed: Jun. 2, 2023
(86) PCT No.: PCT/US2023/024237

§ 371 Date: Dec. 10, 2024

Related U.S. Application Data
(60) Provisional application No. 63/366,533, filed on Jun. 16, 2022.

(51) Int. Cl. H04W 52/02; H04B 7/185; H04W 64/00

(52) U.S. Cl. CPC H04W 52/0216; H04B 7/18513; H04W 64/00

(57) ABSTRACT

To configure activation of a power saving mode, PSM, in a user equipment UE, a network device determines a timer value for a timer delimiting a period during which the UE to remain active immediately upon receiving the timer value and prior to transitioning to the PSM. The network device transmits the timer value to the UE.

### FIELD OF THE DISCLOSURE

This disclosure relates generally to methods, devices and articles in wireless communication systems, such as 3GPP communication systems.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The objectives behind developing the fifth generation (5G) technology include providing a unified framework for such types of communication as enhanced mobile broadband (eMBB), ultra-reliable low-latency communications (URLLC), and massive machine type communication (mMTC).

The 5G technology relies primarily on legacy terrestrial networks. However, the 3rd Generation Partnership Project (3GPP) organization has proposed to extend 5G communications to non-terrestrial networks (NTNs) with 5G new radio (NR) technologies, or with the Long-Term-Evolution (LTE) technologies tailored for the Narrowband Internet-of-Thing (NB-IoT) or the enhanced Machine Type Communication (eMTC) scenarios. In an NTN, a Radio Frequency (RF) transceiver is mounted on a satellite, an unmanned aircraft system (UAS) also called drone, balloon, plane, or another suitable apparatus. For simplicity, the discussion below refers to all such apparatus as satellites. In addition to satellites, an NTN can include satellite or NTN gateways (sat-gateways) that connect the Non-Terrestrial Network to a public data network, feeder links between sat-gateways and satellites, service links between satellites, and inter-satellite links (ISL) when satellites form constellations.

A satellite can belong to one of several types based on altitude, orbit, and beam footprint size. The types include Low-Earth Orbit (LEO) satellite, Medium-Earth Orbit (MEO) satellite, Geostationary Earth Orbit (GEO) satellite, UAS platform (including High Altitude Platform Station, HAPS), and High Elliptical Orbit (HEO) satellite. GEO satellites are also known as the Geosynchronous Orbit (GSO) satellites, and LEO/MEO satellites are also known as the non-GSO (NGSO) satellites.

A GSO satellite can communicate with one or several sat-gateways deployed over a satellite targeted coverage area (e.g. a region or even a continent). A non-GSO satellite at different times can communicate with one or several serving sat-gateways. An NTN is designed to ensure service and feeder link continuity between successive serving sat-gateways, with sufficient time duration to proceed with mobility anchoring and hand-over.

A satellite can support a transparent or a regenerative (with on board processing) payload, and typically generates several beams for a given service area bounded by the field of view. The footprints of the beams typically have an elliptic shape and depend on the on-board antenna configuration and the elevation angle. For a transparent payload implementation, a satellite can apply RF filtering and frequency conversion and amplification, and not change the waveform signal. For a regenerative payload implementation, a satellite can apply RF filtering, frequency conversion and amplification, demodulation and decoding, routing, and coding/modulation. This approach is effectively equivalent to implementing most of the functions of a base station, e.g., a gNB.

NB-IoT and eMTC technologies are expected to be particularly suitable for IoT devices operating in remote areas with limited or no terrestrial connectivity. Such IoT devices can be used in a variety of industries including for example transportation (maritime, road, rail, air) and logistics; solar, oil, and gas harvesting; utilities; farming; environmental monitoring; and mining. However, to ensure the required IoT connectivity, deployment of these technologies requires satellite connectivity to provide coverage beyond terrestrial deployments. Satellite NB-IoT or eMTC is defined in a complementary manner to terrestrial deployments.

In these and other applications, a UE can experience time-discontinuous coverage, and have coverage only occasionally. Moreover, because a UE in such applications often has limited power, the UE can operate in a power saving mode (PSM) with no radio resource control (RRC) protocol relationship between the UE and the network for multiple hours or days. Then the UE can wake up for a short period of time to inform the network of its existence and to perform DL/UL transmissions for buffered communications accumulated during the PSM. Therefore, when the periods of time when the UE is awake do not align well with the periods of NTN coverage, the UE can miss a relatively infrequent opportunity to communicate with the network, and accordingly cause the network to deregister or detach the UE prematurely.

### SUMMARY

Generally speaking, the techniques of this disclosure allow a UE to utilize the power saving mode (PSM) more efficiently. While in PSM, the UE has no connectivity with the network according to a protocol for controlling radio resources The UE and the network use these techniques to align the UE active time with periods of satellite coverage, so as to reduce the probability that the network deregisters or detaches the UE prematurely.

An example embodiment of these techniques is a method for configuring activation of a PSM in a UE, which is implemented in a network device and includes determining, by the one or more processors, a timer value for a timer delimiting a period during which the UE, immediately upon receiving the timer value, remains active prior to transitioning to the PSM; and transmitting, by the one or more processors to the UE, the timer value.

Another example embodiment of these techniques is a method for configuring PSM in a UE, implemented in a core network and including: receiving, by one or more processors via a non-terrestrial network (NTN), a message from the UE; determining, by the one or more processors, that upon expiration of a timer set to an initial value delimiting a period during which the UE remains in the PSM prior to waking up, the UE will not have network coverage; in response to the determining, generating, by the one or more processors, an extended timer value for the timer that is greater than the initial value; and transmitting the extended timer value to the UE.

Another example embodiment is a network device comprising one or more processors and configured to implement one of the methods above.

Still another embodiment of these techniques is a method for activating a power saving PSM in a UE, the method including receiving, by one or more processors from a base station connected to a core network, while operating in a connected mode of a protocol for controlling radio resources, a timer value; activating, by the one or more processors immediately upon receiving the timer value, a timer having the timer value; and upon expiration of the timer, transitioning to a power saving mode (PSM).

Yet example embodiment is a UE comprising one or more processors and configured to implement the methods above.

### BRIEF DESCRIPTION OF THE DRAWINGS

FIG. 1 is a block diagram of an example wireless communication system in which a user device and a base station of this disclosure can implement the location update and power saving techniques of this disclosure;

FIG. 2 is a block diagram of an example base station in which a centralized unit (CU) and a distributed unit (DU) that can operate in the system of FIG. 1;

FIG. 3A is a block diagram of an example NTN node with transparent payload implementation;

FIG. 3B is a block diagram of an example NTN node with transparent payload implementation, in which a base station connects to multiple satellites via the same sat-gateway;

FIG. 4A illustrates an exemplary user plane protocol stack for use with the architecture of FIG. 3A;

FIG. 4B illustrates an exemplary control plane protocol stack for use with the architecture of FIG. 3A;

FIG. 5 illustrates an example configuration according to which a UE implements enhanced Discontinuous Reception (eDRX);

FIG. 6 illustrates an example configuration according to which a UE implements a Power Saving Mode (PSM);

FIG. 7 illustrates an example scenario in which a UE has satellite coverage during certain time periods separated by intervals of non-coverage;

FIG. 8A illustrates an example scenario in which the network de-registers a UE operating in the PSM due to the misalignment between the UE active time and the satellite coverage;

FIG. 8B illustrates an example scenario in which a UE operating in the PSM remains active even after exiting an area of satellite coverage;

FIGS. 9A and 9B are messaging diagrams of example scenarios in which the UE provides up-to-date location information to the network in the Attach or in the Tracking Area Update procedure, for aligning the PSM configuration with a period of satellite coverage;

FIGS. 10A and 10B are messaging diagrams of example scenarios in which the UE has the capability to estimate the satellite coverage, for aligning the PSM configuration with a period of satellite coverage, and provides suggested timer values to the network in the Attach or in the Tracking Area Update procedure;

FIG. 11 is a messaging diagram of an example scenario in which the network extends the mobile reachable timer for the UE upon determining that the PSM configuration of the UE likely will not match the period of satellite coverage;

FIGS. 12A and 12B are flow diagrams of example methods for determining how to apply the PSM configuration and when to perform TAU in the PSM, which can be implemented by a user equipment capable of obtaining its location information;

FIGS. 13A and 13B are flow diagrams of example methods for determining how to apply the PSM configuration and when to perform TAU in the PSM, which can be implemented by a user equipment capable of estimating/predicting the satellite coverage of this disclosure;

FIG. 14 is a flow diagram of an example method for initiating a procedure for determining whether to extend the mobile reachable timer, which can be implemented in a network device of this disclosure;

FIG. 15 is a flow diagram of an example method for configuring a UE for configuring activation of PSM which can be implemented in a network device of this disclosure; and

FIG. 16 is a flow diagram of an example method for initiating a procedure for configuring activation of PSM, which can be implemented in a UE of this disclosure.

### DETAILED DESCRIPTION OF THE DRAWINGS

As discussed in more detail below, a user equipment (UE) and/or a network node of a radio access network (RAN) can use the techniques of this disclosure for managing early data communication and transitioning a UE between states of a protocol for controlling radio resources between the UE and the RAN.

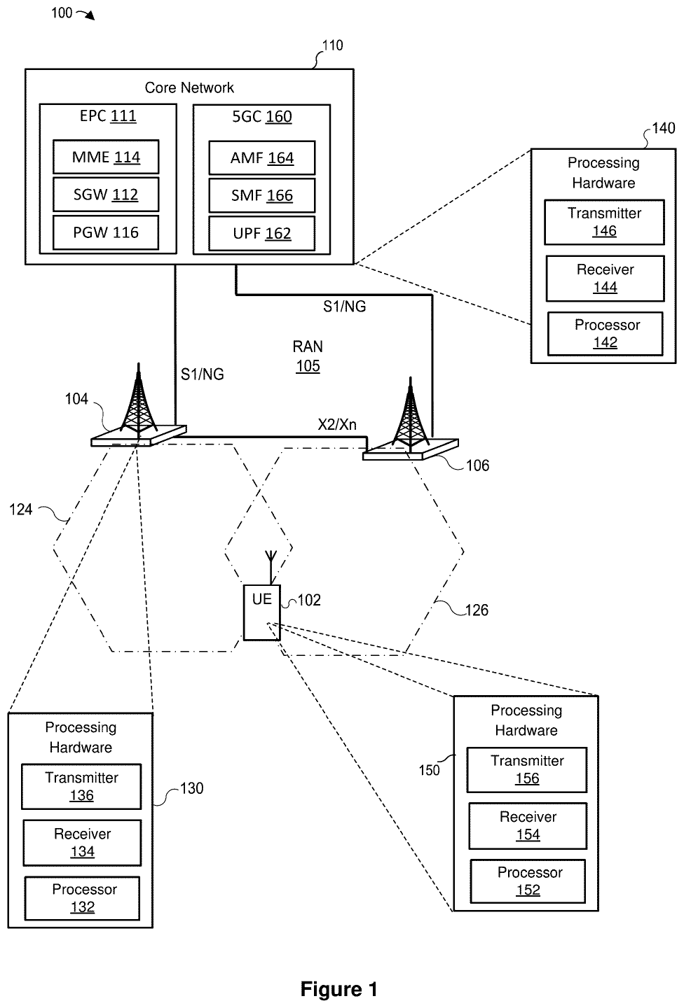

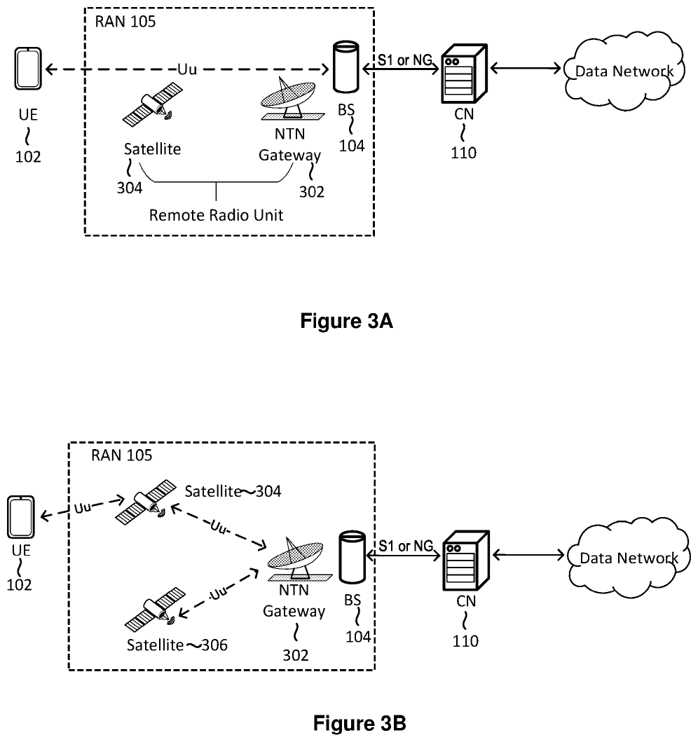

Referring first to FIG. 1, an example wireless communication system 100 includes a UE 102, a base station (BS) 104, a base station 106, and a core network (CN) 110. The base stations 104 and 106 can operate in a RAN 105 connected to the core network (CN) 110 and other base station components, such as satellites, as will be described with reference to FIGS. 3A and 3B. The CN 110 can be implemented as an evolved packet core (EPC) 111 or a fifth generation (5G) core (5GC) 160, for example. The CN 110 can also be implemented as a sixth generation (6G) core and future evolutions.

The base station 104 covers a cell 124, and the base station 106 covers a cell 126. If the base station 104 is a gNB, the cell 124 is an NR cell. If the base station 104 is an ng-eNB or eNB, the cell 124 is an evolved universal terrestrial radio access (E-UTRA) cell. Similarly, if the base station 106 is a gNB, the cell 126 is an NR cell, and if the base station 106 is an ng-eNB or eNB, the cell 126 is an E-UTRA cell. The cells 124 and 126 can be in the same Radio Access Network Notification Areas (RNA) or different RNAs. In general, the RAN 105 can include any number of terrestrial and non-terrestrial base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

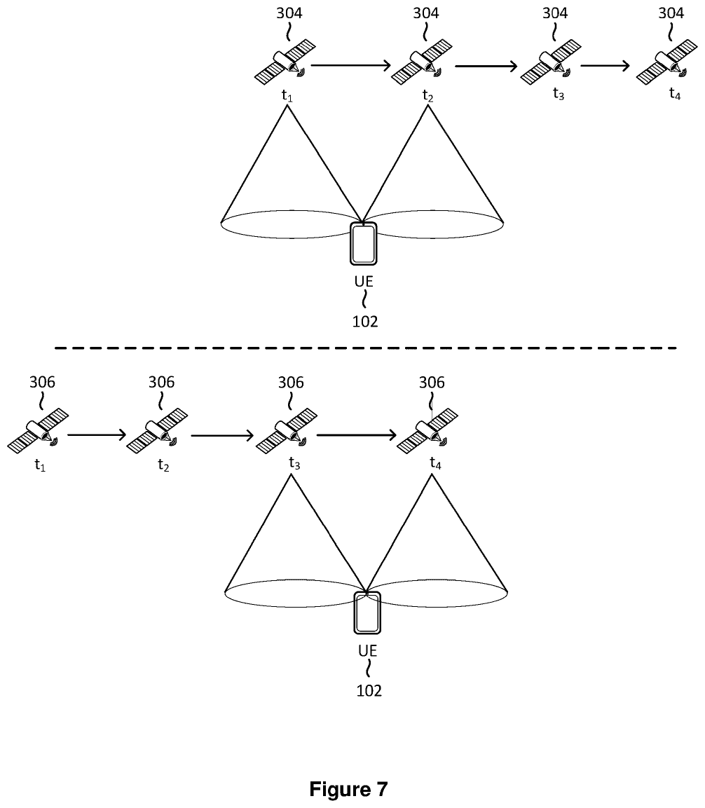

As illustrated in FIG. 1, the base station 104 supports a cell 124, and the base station 106 supports a cell 126. The cells 124 and 126 can partially overlap, so that the UE 102 can select, reselect, or hand over from one of the cells 124 and 126 to the other. Satellite base stations may provide additional RAN 105 coverage as described with reference to FIG. 7. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC INACTIVE or RRC_IDLE state of the RRC protocol. The UE 102 may further utilize the techniques of this disclosure when the radio connection between the UE 102 and the RAN 105 is disconnected and operating in a PSM where no radio resource control (RRC) protocol relationship exists between the UE and the network.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a processor 132 to process data that the base station 104 will transmit in the downlink direction, or process data received by the base station 104 in the uplink direction. The processing hardware 130 can also include a transmitter 136 configured to transmit data in the downlink direction. The processing hardware further can include a receiver 134 configured to receive data in the uplink direction. The base station 106 can include generally similar components. In particular, components 140, 142, 144, and 146 of the base station 106 can be similar to the components 130, 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction, or process data received by UE 102 in the downlink direction. The processing hardware 150 can also include a transmitter 156 configured to transmit data in the downlink direction. The processing hardware further can include a receiver 154 configured to receive data in the uplink direction.

In some embodiments, the RAN 105 supports Integrated Access and Backhaul (IAB) functionality. In some implementations, the DU 174 operates as an IAB-node, and the CU 172 operates as an IAB-donor. In some embodiments, the RAN 105 supports Non-Terrestrial Network (NTN) functionality.

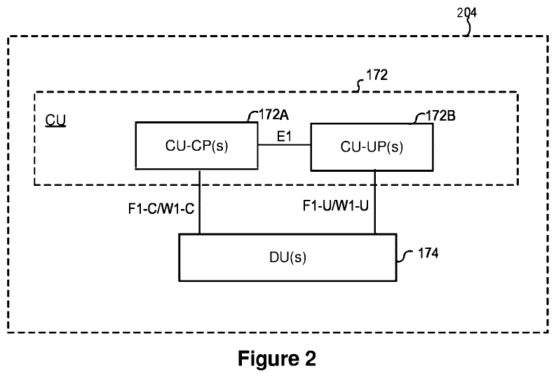

FIG. 2 depicts an example distributed or disaggregated implementation of any one of the base stations 104, 106. In this illustration, the base station 204 includes a central unit (CU) 172 and a distributed unit (DU) 174 (but the base station may include more than one DU). The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller. In some implementations, the CU 172 can include a radio link control (RLC) controller configured to manage or control one or more RLC operations or procedures. In further implementations, the CU 172 does not include an RLC controller.

Similarly, the DU 174 also includes processing hardware such as one or more general-purpose processors (e.g., CPUs) and computer-readable memory storing machine-readable instructions executable on the one or more general-purpose processors, and/or special-purpose processing units. For example, the processing hardware can include a MAC controller configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through an E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

FIG. 3A illustrates a certain type of NTN deployment referred to as transparent payload architecture, which involves a satellite gateway 302 and a “transparent” satellite 304 for extending the range of the Uu interface. This NTN deployment may be incorporated into the RAN 105 of FIG. 1 as another base station or an extension of the BS 104 (or the BS 106). The satellite 304 implements a frequency conversion and a Radio Frequency (RF) amplifier in both the uplink and downlink directions. The satellite function is similar to that of an analogue RF repeater. As a result, the satellite 304 repeats the Uu radio interface from the feeder link (between the NTN gateway and the satellite) to the service link (between the satellite and the UE) in the downlink direction and vice versa in the uplink direction. The Satellite Radio Interface (SRI) on the feeder link is the Uu, and the NTN gateway 302 supports all necessary functions to forward the signal of the Uu interface. The NTN gateway 302 can be placed at the same site as the base station (e.g., eNB, gNB) 104's location, or be connected to the base station 104 at a distance via a wired link. It is also possible to connect more than one NTN gateway to a base station. Different transparent satellites may be connected to the same base station on the ground, via the same NTN gateway, or via different NTN gateways. FIG. 3B illustrates the case where two different satellites (304 and 306) are connected to the same base station 104 via the same NTN gateway 302, and these two satellites (304 and 306) are covering the Earth surface using two different Physical Cell IDs (PCIs).

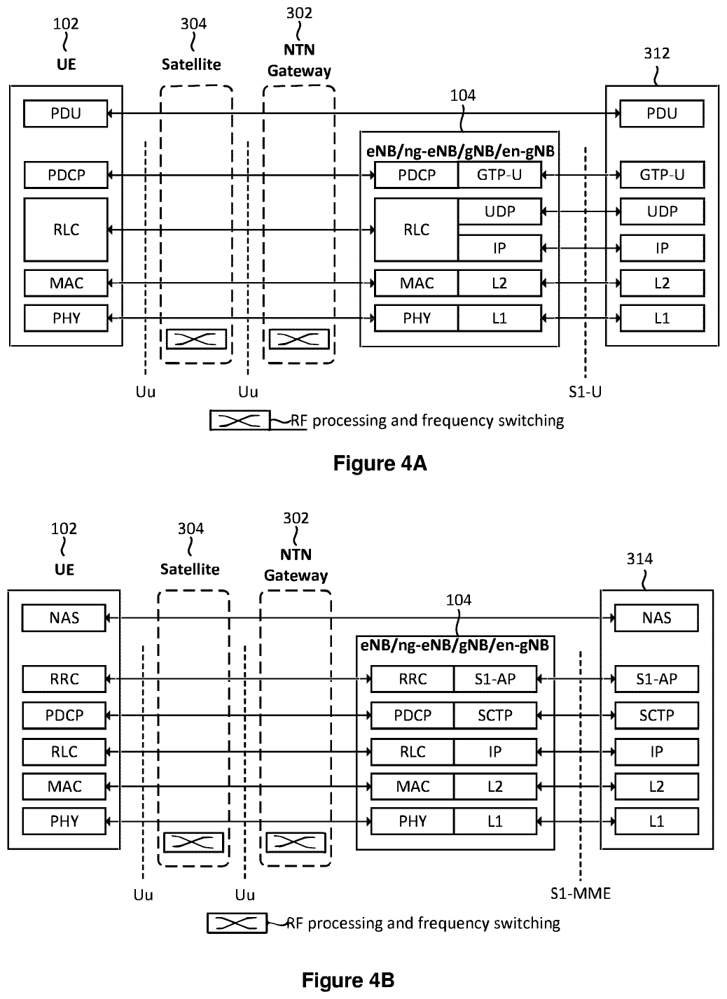

The NTN user plane protocol stack involving the UE 102, satellite 304, NTN gateway 302, the BS 104 and module 312 (i.e., the EPC 111's S-GW 112 or 5GC 160's SMF 166) is illustrated in FIG. 4A. The diagram of the NTN user plane protocol stack is similar to that of the terrestrial network (TN) with the addition of two new nodes, the satellite 304 and the NTN gateway 302, being placed in the middle of the Uu interface. Similarly, the NTN control plane protocol stack illustrated in FIG. 4B is also similar to that of the terrestrial network counterpart with module 314 being EPC 111's MME 114 or 5GC 160's AMF 164.

In terms of the satellite moving pattern, there are three types of service links that are supported in NTN:
Earth-fixed: provisioned by beam(s) continuously covering the same geographical areas all the time (e.g., the case of GEO/GSO satellites).
Quasi-Earth-fixed: provisioned by beam(s) covering one geographic area for a limited period and a different geographic area during another period (e.g., the case of LEO/MEO satellites capable of using steerable beams)·
Earth-moving: provisioned by beam(s) whose coverage area slides over the Earth surface (e.g., the case of LEO/MEO satellites using fixed or non-steerable beams).

With LEO/MEO satellites, the eNB can provide either quasi-Earth-fixed cell coverage or Earth-moving cell coverage. With GEO satellites, the eNB can provide Earth fixed cell coverage.

Although the transparent payload architecture illustrated in FIGS. 3A/3B is the current focus of the 3GPP development, the regenerative payload architecture that installs the BS functions on the satellite is also a possible NTN deployment in the future. In such an architecture, the Uu only exists between the satellite and the UE. For example, a satellite may implement functions of a DU(s) 174 of FIG. 2. In general, the techniques of this disclosure can apply to the transparent payload architecture as well as the regenerative payload architecture.

Extended Discontinuous Reception (eDRX) is an extension of the DRX feature that is used by IoT or MTC devices to further reduce power consumption while a UE is in an RRC_IDLE mode. With the DRX mechanism, a user device can go into a sleep mode within an RRC_IDLE mode for a certain period of time and then wake up after the sleep period to monitor the DL signal from the base station. The DRX cycle defines the time interval between two consecutive time periods when the UE is awake. The eDRX enhancement is to extend the DRX cycles to allow a device to remain in the sleep mode for a longer period of time. The eDRX enhancement can be used to achieve additional power savings relative to DRX mode.

In one example, an LTE device is configured with a paging cycle (i.e., DRX cycle) of up to 2.56 seconds. With this configuration, the UE wakes up and monitors paging from the network every 2.56 seconds, during a paging occasion (PO) in a paging frame (PF). On the other hand, an LTE device that supports eDRX can be configured with an eDRX cycle of up to 2621.44 seconds, which allows the device to wake up for one Paging Time Window (PTW) every 2621.44 seconds. Therefore, an LTE device supporting the eDRX feature can consume significantly less power compared to devices that do not support this feature. Moreover, an NB-IoT device (which supports eDRX by default) can be configured with an eDRX cycle of up to 10485.76 seconds, which allows the device to wake up once every 2.9 hours, and hence the NB-IoT device can save even more power compared to the LTE device supporting eDRX. A device supporting the eDRX feature does not need to wake up for the entire PTW, which ranges from 1.28 seconds to 20.48 seconds, but only wakes up at the paging occasions determined by the legacy DRX configuration/parameters inside the PTW.

The UE and the network (e.g., the MME or AMF) negotiate DRX and eDRX parameters using the following messages: Attach Request, Attach Accept, Tracking Area Update Request, and Tracking Area Update Accept. During the attach procedure, the UE provides the preferred values of the DRX and eDRX parameters in the Attach Request message, and the network provides the final values of these parameters in the Attach Accept message. The UE can transmit an Attach Complete message to the network in response to the Attach Accept message. Similarly, during the Tracking Area Update (TAU) procedure, the preferred values of the DRX and eDRX parameters are provided by the UE in the Tracking Area Update Request message, and the final values of these parameters are provided by the network in the Tracking Area Update Accept message. The UE can transmit a TAU Complete message to the network in response to the TAU Accept message. In case of the DRX configuration for non-NB-IoT devices, the network will only accept or reject the preferred DRX configuration set by the UE in the Attach Request/Tracking Area Update Request and will not provide the revised configuration in the Attach Accept/Tracking Area Update Accept message.

The DRX cycle length can be configured using the following example values: {320 ms, 640 ms, 1280 ms, 2560 ms}. For an NB-IoT device, The PTW length can be configured from the following values: {2.56 s, 5.12 s, 7.68 s, 10.24 s, 12.8 s, 15.36 s, 17.92 s, 20.48 s, 23.04 s, 25.6 s, 28.16 s, 30.72 s, 33.28 s, 35.84 s, 38.4 s, 40.96 s}, and the eDRX cycle length can be configured from the following values: {5.12 s, 10.24 s, 20.48 s, 40.96 s, 61.44 s, 81.92 s, 102.4 s, 122.88 s, 143.36 s, 163.84 s, 327.68 s, 655.36 s, 1310.72 s, 2621.44 s, 5242.88 s, 10485.76 s}. It should be noted that if the eDRX cycle length is configured as 5.12 s, there will be no PTW for the UE and the UE will just perform the legacy DRX operation with the DRX cycle length equal to 5.12 s.

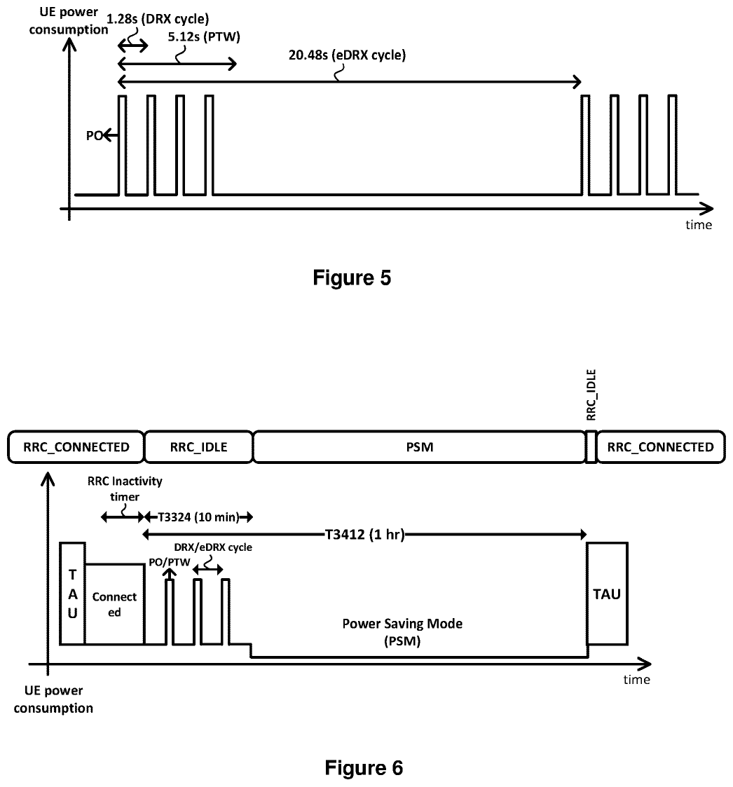

FIG. 5 illustrates an example in which a UE is configured with the eDRX cycle equal to 20.48 seconds, the PTW equal to 5.12 seconds, and the DRX cycle equal to 1.28 seconds. In this example, the UE is configured to wake up 4 times during a PTW (each a paging occasion (PO)), in order to monitor the paging message. Except for the PTW, the UE can completely turn off its radio module for approximately 15.36 seconds per eDRX cycle and thus save a significant amount of power.

Power Saving Mode (PSM) in general reduces (sometimes significantly) power consumption of IoT devices. A UE that supports PSM has more control over power management suitable for its applications, which can be highly advantageous because there is a wide range of IoT applications. The PSM mode is generally similar to power-off, but the UE remains registered to the network while in PSM. Although the UE remains registered to the network during PSM, the UE does not have a radio resource control (RRC) protocol relationship with the network during PSM. Similar to the eDRX mechanism, the UE controls PSM using two timers configured through the Attach or the TAU procedure. The first timer is T3324, which delimits the time period during which the UE must remain in the idle mode (and monitor paging) upon transitioning from RRC_CONNECTED to RRC_IDLE. The second timer is the extended T3412 timer which controls the periodicity (i.e., the time interval) with which a UE performs periodic TAU.

The UE may first include a T3324 value in the Attach Request message or TAU Request message, and then the network (e.g., MME 114 or, in another implementation, AMF 164) can respond with a confirmed T3324 value to the UE in the Attach Accept message or TAU Accept message. The UE starts the timer T3324 upon transitioning from the CONNECTED state to the IDLE state. The UE transitions to the Power Saving Mode upon expiration of the T3324 timer. The T3324 timer delimits the time period during which the device remains reachable for the mobile terminating (MT) event upon transitioning from the connected state to the idle state. When the network receives T3324 in the Attach Request or in the TAU Request message, the network accounts for its local configuration while determining the final T3324 value. In some implementations, the MME does not include the T3324 value in the Attach Accept or the TAU Accept message if the T3324 value was not included in the Attach Request or the TAU Request message. The UE that supports the PSM feature is available for paging when T3324 is still running. In some implementations, the network can configure T3324 with the value ‘0’ in the Attach Accept message or TAU Accept message. In such implementations, the UE enters the Power Saving Mode immediately after transitioning to the RRC_IDLE state. The T3324 value ranges from 0 to 31, and the time unit is one of the following: {2 seconds, 1 minute, one deci-hour}.

Because T3324 is a timer running on the UE, the network starts a counterpart timer, referred to as “active timer,” upon determining that the UE has transitioned from the CONNECTED to the IDLE state. The active timer has the same value as T3324. While the active timer is still running, the network assumes the UE is still available for paging and accordingly pages the UE upon detecting any pending MT event. When the active timer expires, the network assumes the UE has transitioned to the PSM, and hence may delay paging of the UE even if there is a pending MT event.

The T3412 timer is also known as the periodic TAU timer. A UE performs periodic TAU upon expiration of the T3412 timer to periodically notify the availability of the UE to the network. The UE may first include a T3412 value during the Attach or the TAU procedure, and then the network responds a T3412 value to the UE in the Attach Accept or the Tracking Area Update Accept message. The UE applies this value while operating in all the tracking areas assigned to the UE, until the UE receives a new value. The UE starts the timer T3412 upon transitioning to the IDLE state, and the network (e.g., MME 114 or, in another implementation, AMF 164) also starts a counterpart timer, “mobile reachable timer,” upon determining the UE has transitioned into the IDLE state. The mobile reachable timer has dependency on the T3412 timer, and it is by default 4 minutes longer than the T3412 timer. The network stops the mobile reachable timer when the network and the UE establish a non-access stratum, NAS, connection. Upon expiration of the mobile reachable timer, the network starts another timer referred to as “implicit detach timer.” If the implicit detach timer expires before the UE contacts the network, the network implicitly detaches the UE.

To support the PSM feature, a UE must be configured with a longer version of T3412 using the T3412 extended value IE. If the UE indicates support of extended periodic timer value (e.g., via a standardized mobile station, MS, network feature support information element, IE) in the Attach Request or the TAU Request message, the network may also include the T3412 extended value IE in the Attach Accept or the TAU Accept message. In addition to the T3412 extended value recommended by the UE, the network accounts for the local configuration while determining a final value for the T3412 extended value. If the network includes the T3412 extended value IE in the Attach Accept or the TAU Accept message, the UE uses the value indicated in the T3412 extended value IE as the value for the timer T3412. The T3412 extended value IE contains the values ranging from 0 to 31, with the time unit selected from the following set: {10 minutes, 1 hour, 10 hours, 2 seconds, 30 seconds, 1 minute, 320 hours}.

FIG. 6 illustrates an example in which a UE is configured with the T3324 timer equal to 10 minutes, and the T3412 timer equal to 1 hour. In this example, the UE performs the periodic TAU once every 1 hour, and stays in the connected state after performing the TAU for a duration defined by the inactivity timer. After the inactivity timer expires, the UE transitions to IDLE state and monitors paging for a duration defined by the T3324 timer, which is 10 minutes in this example. Upon expiration of the T3324 timer, the device enters the PSM and begins to consume almost no power. The device wakes up again upon expiration of T3412 to transition to RRC_IDLE, and then performs TAU in RRC_CONNECTED mode.

Table 1 below illustrates the UE timers and the network timers relevant to the PSM feature, and the corresponding actions performed by the UE/network upon expiration of these timers:

| UE side | NW side | Upon Expiry |
|---|---|---|
| T3324 | Active Timer | UE transitions to the PSM |
| T3412 | Mobile Reachable | Performs TAU/Starts |
| | Timer | the Detach Timer |
| Inactivity | Inactivity Timer | UE Transitions to |
| Timer | | RRC_IDLE |

FIG. 7 illustrates an example scenario in which the LEO satellite 304 (whose locations are shown at different times t1, t2, t3, t4) serves a UE (such as the UE 102 for example) between t1 and t2, and another LEO satellite 306 (whose locations are also shown at different times t1, t2, t3, t4) serves the UE between t3 and t4. In the time period between t2 and t3, the UE 102 is not served by any satellite or any terrestrial base station and therefore is out of coverage. Typically, when a UE loses coverage by the serving cell, the UE starts searching for other cells and then camps on a suitable cell. However, in the example illustrated in FIG. 7, even if the UE 102 starts searching for other cells immediately after t2, the UE cannot find a cell, and therefore the search for other cells results in the UE only expending power. To optimize power consumption at the UE in particular NTN scenarios such as the one depicted in FIG. 7, the UE may not be required to perform the cell search and can deactivate the Access Stratum (AS) functions during the period when the UE is not within the area of coverage of a satellite. However, doing so would require the UE to have the knowledge of when the UE will be outside the area of coverage, and when the UE will be within an area of coverage again, in order to activate its cell search or AS functions again before the UE falls into the coverage of another NTN cell. Note that FIG. 7 does not assume that the UE 102 is stationary.

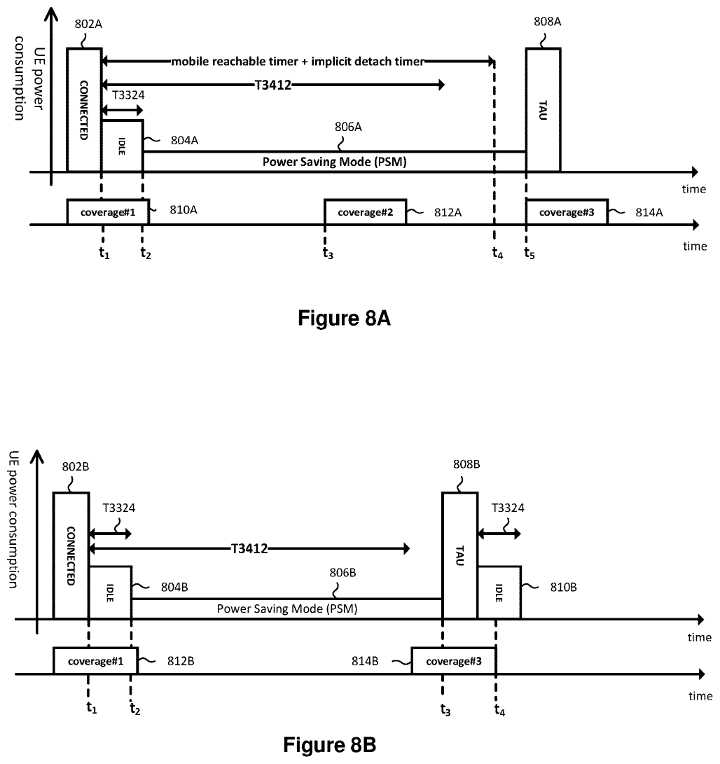

FIG. 8A illustrates an example scenario in which the UE receives a PSM configuration that does not align with the satellite coverage. In this example, the UE initially operates in the RRC_CONNECTED state 802A and receives a PSM configuration containing a T3412 value and a T3324 value. The UE transitions to the RRC_IDLE state 804A (also transitions to ECM_IDLE) at t₁ upon receiving the RRC Connection Release message or upon expiration of the inactivity timer shown in FIG. 6. The UE remains in the IDLE state and monitors paging until the timer T3324 expires at t₂. When the timer T3324 expires at t₂, the UE transitions to PSM 806A. In this example, the UE can communicate with the network during the entire intervals when the UE operates in the CONNECTED state 802A and the IDLE state 804A, because the UE is within the satellite coverage 810A. The UE then starts the timer T3412 upon transitioning to the IDLE state, and the network (e.g., MME 114 or, in another implementation AMF 164) also starts the mobile reachable timer at the same time, where the mobile reachable timer is 4 minutes longer than the T3412 in typical implementations. (The UE remains in PSM at t₃ and does not communicate within the satellite coverage 812A.) In this example, due to discontinuous satellite coverage, the UE is not able to contact the network within a short time after the mobile reachable timer expires (e.g., about 4 minutes after T3412 expires at the UE), and hence the network determines to detach the UE at t₄. Later at t₅, the UE detects that it is within the satellite coverage 814A and initiates a Radio Resource Control, RRC, connection setup procedure for sending the TAU request to the network. However, as the network has already detached the UE at t₄, and the UE is not aware of this event, the UE unsuccessfully expends power to attempt to perform a TAU procedure 808A with the network at t₅.

FIG. 8B illustrates another example in which the UE receives a PSM configuration that does not align with the satellite coverage. In this example, the UE initially operates in the RRC_CONNECTED state 802B and receives a PSM configuration containing a T3412 value and a T3324 value. The UE transitions to the IDLE state 804B and starts both T3412 and T3324 at t₁, and then further enters PSM 806B at t₂ upon expiration of T3324. In this example, the UE is able to perform TAU 808B and contact the network at t₃, which occurs after T3412 expires and before the network detaches the UE, because the UE is within the satellite coverage 814B at t₃. However, as the UE is not within the satellite coverage 814B during the entire time a timer T3324 is running, the network may try to reach the UE by sending one or multiple paging messages to the UE after t₄, which likely will not reach the UE. Such paging messages unnecessarily consume radio resources and otherwise burden the network. In this example, the UE may also need to wake up for extra duration after t₄, which consumes unnecessarily UE's power. In addition, because the UE would stay in the CONNECTED state (e.g., 802B, 808B) for a duration depending on the real traffic situation (i.e., the duration is unpredictable), it is difficult for the network to configure, and for the UE to recommend, a proper T3324 value that makes the total UE active time align with the satellite coverage.

Additionally, in order to configure a UE with PSM that aligns with occurrence(s) of the satellite coverage, the network may need to obtain UE position/location information before determining the configuration. However, acquiring the location information for the UE while the UE is in PSM is challenging as the network has no control over the UE and, as a result, it is the UE that needs to trigger location reporting.

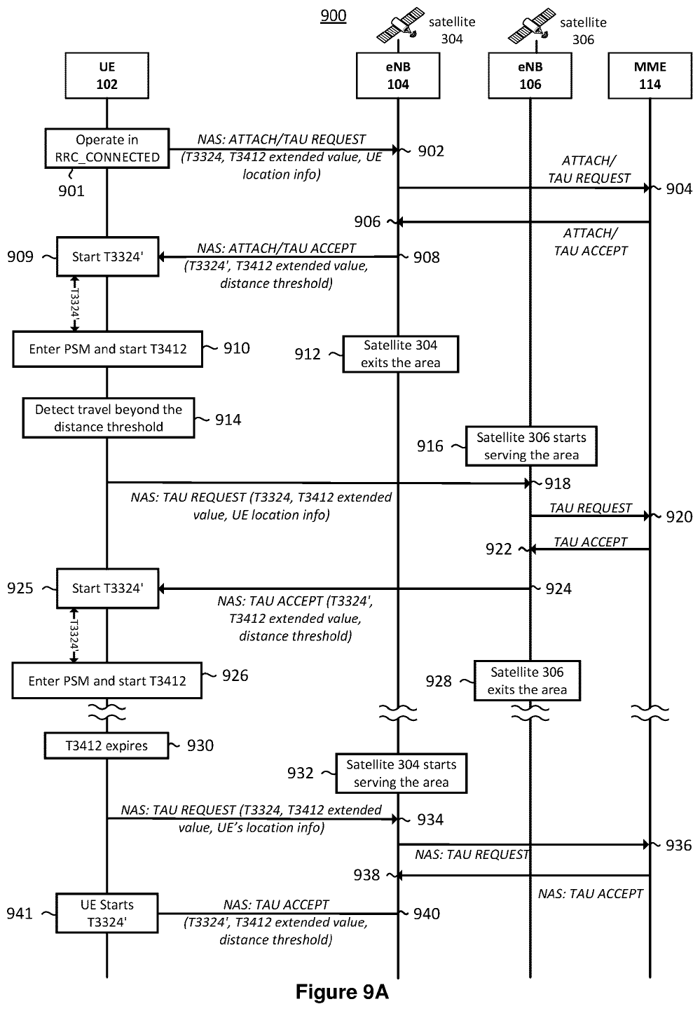

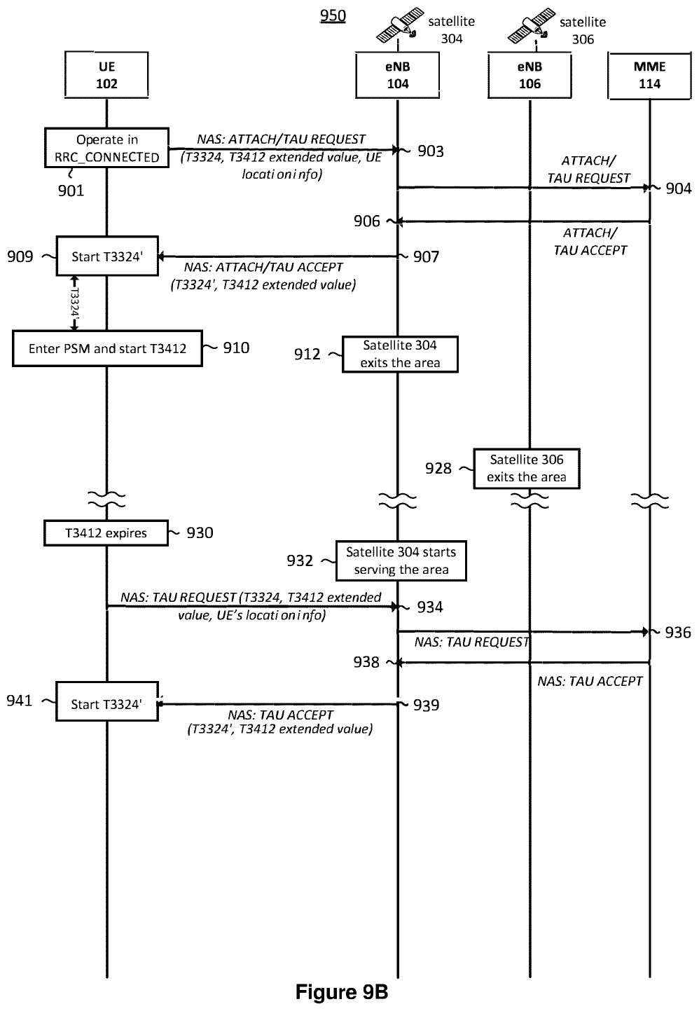

FIG. 9A is a messaging diagram of an example scenario 900 in which the UE provides its up-to-date location information to the network in the Attach or in the Tracking Area Update procedure, for aligning the PSM configuration with a period of satellite coverage. Although the BS 104, 106 are shown to be eNB radio access technology satellites, the BS 104, 106 could be implemented as any type of satellites 304, 306 compliant with 4G, 5G, 6G, or future standards. The UE 102 initially connects to the eNB 104 via the service link provided by the satellite 304 and operates 901 in the RRC_CONNECTED state. Initially, the UE 102 transmits 902 a NAS message such as an ATTACH REQUEST or a TAU REQUEST message to the eNB 104, and then the eNB 104 encapsulates the ATTACH REQUEST or the TAU REQUEST message in an S1-AP message (i.e., a control plane message between the RAN and the core, such as, the Initial UE Message) and forwards 904 it to the MME 114. When sending the ATTACH REQUEST or the TAU REQUEST message, the UE 102 may indicate its support for extended periodic timer value (via the MS network feature support IE) and include a T3324 value and a T3412 extended value in the message. The UE 102 also provides its location information (e.g., its GNSS coordinate) in the ATTACH REQUEST or the TAU REQUEST message. The MME 114, after receiving the ATTACH REQUEST or the TAU REQUEST message, determines/calculates the periods when the UE 102 will be covered by at least one NTN cell and the periods when the UE 102 will not be covered by any NTN cell, based on the satellite ephemeris information (i.e., satellite constellation information) provided to or pre-installed in the MME 114 beforehand, the UE location information given by the UE 102 in the ATTACH or TAU procedure, and some other assistance information such as the cell/beam footprint size and/or the antenna panel tilt. The MME 114 then determines the PSM configuration for the UE 102 that matches the periods of the satellite coverage determined/calculated by the MME 114.

In response to the ATTACH REQUEST or the TAU REQUEST message, the MME 114 encapsulates the ATTACH ACCEPT or the TAU ACCEPT message in the Initial UE Message and sends 906 it to the eNB 104, and the eNB 104 then forwards 908 the ATTACH ACCEPT or the TAU ACCEPT message to the UE 102. The MME 114 provides in the ATTACH ACCEPT or the TAU ACCEPT message the determined PSM configuration for the UE 102 that matches the periods of the satellite coverage. In one implementation, the determined PSM configuration contains a T3412 extended value IE and a UE active timer used to determine when the UE 102 should transition to the PSM. UE transitions to the PSM upon expiration of the UE active timer, which starts immediately upon UE receiving the PSM configuration from the network. Because the UE behavior with respect to the UE active timer is generally similar to that of T3324, the UE active timer can be referred to as T3324′ for the rest of the disclosure.

In one implementation, the MME 114 may include the original T3324 value IE instead of including an IE specifically defined to convey the T3324′ value in the PSM configuration. In one implementation, in addition to the PSM configuration, the MME 114 also provides a distance threshold in the ATTACH ACCEPT or the TAU ACCEPT message, which the UE uses to determine whether it needs to perform TAU according to the distance it has traveled. Alternative to the above implementation, the above-mentioned distance threshold is broadcasted by the eNB 104 in the system information.

After receiving the ATTACH ACCEPT or the TAU ACCEPT message, the UE 102 starts 909 the timer T3324′. Upon expiration of T3324′, the UE 102 then enters 910 PSM and starts timer T3412. In some implementations, the UE 102 also starts an inactivity timer after receiving the ATTACH ACCEPT or the TAU ACCEPT message, and the UE 102 then transitions to the RRC_IDLE state before transitioning to the PSM, in response to the expiration of the inactivity timer. In other implementations, after receiving the ATTACH ACCEPT or the TAU ACCEPT message, the UE further receives an RRC Connection Release message from the eNB 104 via the satellite 304 and transitions to the RRC_IDLE state before transitioning to the PSM, in response to the RRC Connection Release message. If the UE 102 transitions to the RRC_IDLE state before transitioning to the PSM, the UE 102 starts T3412 upon transitioning to the RRC_IDLE state rather upon transitioning in the PSM.

At a later time, the UE 102 operating in PSM is no longer within the service area of the satellite 304, because the satellite 304 has moved 912 to a new position that makes the satellite 304 unable to provide coverage to the UE 102. Afterward, the UE 102 detects 914 that it has traveled a distance greater than the distance threshold provided by the MME 114 or by the eNB 104. Even later, when the UE 102 detects that the satellite 306 has started 916 serving the area (i.e., has started covering the UE 102), the UE 102 performs the RRC connection setup procedure with eNB 106 and transmits 918 the TAU REQUEST message to the eNB 106 to inform MME 114 of the updated UE location. The UE 102 includes its location information (e.g., its GNSS coordinate), and may also include a T3324 value and a T3412 extended value in the TAU REQUEST message.

The eNB 106 forwards 920 the TAU REQUEST message to the MME 114 upon receiving the message from the UE 102, and then receives 922 the TAU ACCEPT message from the MME 114 in response to the TAU REQUEST message. The TAU ACCEPT message may include an updated T3324′ value, an updated T3412 extended value, and an updated distance threshold, where the MME 114 determines these updated values based on the updated UE location. The UE 102, upon receiving 924 the TAU ACCEPT message forwarded by eNB 106, replaces the stored T3324′ value and T3412 extended value by the new values provided in the TAU ACCEPT message, and then starts 925 the timer T3324′. Upon expiration of T3324′, UE transitions 926 to the PSM and starts the timer T3412. In some cases, the UE 102 may transition to the RRC_IDLE state before transitioning to the PSM. In these cases, the UE 102 would start T3412 earlier at the time when the UE 102 transitions to the RRC_IDLE state. Soon after the UE 102 transitions to the PSM, the satellite 306 moves 928 to a new position that makes the satellite 306 unable to cover the UE 102.

After a relatively long period of time since the UE transitioned to the PSM, timer T3412 expires 930. The UE 102 at this time needs to initiate periodic TAU with the MME 114. The UE 102 in this scenario waits until the upcoming satellite (e.g., the satellite 304 connected to the eNB 104) starts 932 serving the area where the UE 102 is currently located, and the UE 102 then transmits 934 the TAU REQUEST message to the MME 114 via the eNB 104. While sending the TAU REQUEST message, the UE 102 may indicate its support of extended periodic timer value (e.g., via the MS network feature support IE) and include a T3324 value, a T3412 extended value, and the UE location in the message. The eNB 104 then forwards 936 the TAU

REQUEST message to the MME 114. In response to the TAU REQUEST message, the MME 114 transmits 938 a TAU ACCEPT message to the UE 102 via the eNB 104, which may contain the updated PSM configuration including an updated T3324′ value and an updated T3412 extended value. The TAU ACCEPT message may also contain an updated distance threshold which is used by the UE to examine whether it needs to perform TAU according to the distance it has traveled. The UE 102, upon receiving 940 the TAU ACCEPT message, replaces the stored T3324′ value and T3412 extended value by the new values contained in the TAU ACCEPT message, and then starts 941 the timer T3324′.

In one implementation, the MME 114 may transmit another instance of T3412 instead of the T3412 extended value IE in the ATTACH ACCEPT or in the TAU ACCEPT message. Upon receiving the ATTACH ACCEPT or the TAU ACCEPT message containing this T3412 instance, the UE 102 starts T3412 immediately rather than starting this timer upon UE transitioning to the RRC_IDLE state or entering PSM. In one implementation, this T3412 instance has the same values or the same value range as the T3412 extended value IE.

FIG. 9B is a messaging diagram of another example scenario 950 in which the UE provides its up-to-date location information to the network in the Attach or in the Tracking Area Update procedure, for aligning the PSM configuration with a period of satellite coverage. This scenario is generally similar to the scenario 900, but here the UE 102 receives only timer values, and does not receive or utilize a distance threshold. The differences between scenarios 900 and 950 are discussed below.

The MME 114 determines the T3324′ value, based on factors discussed above such as the current location of the UE 102 and the satellite ephemeris information, and transmits 907 the T3324′ value to the UE 102 in the ATTACH ACCEPT or the TAU ACCEPT message. The MME 114 in this scenario does not include a distance threshold in the in the ATTACH ACCEPT or the TAU ACCEPT message transmitted 939 to the UE.

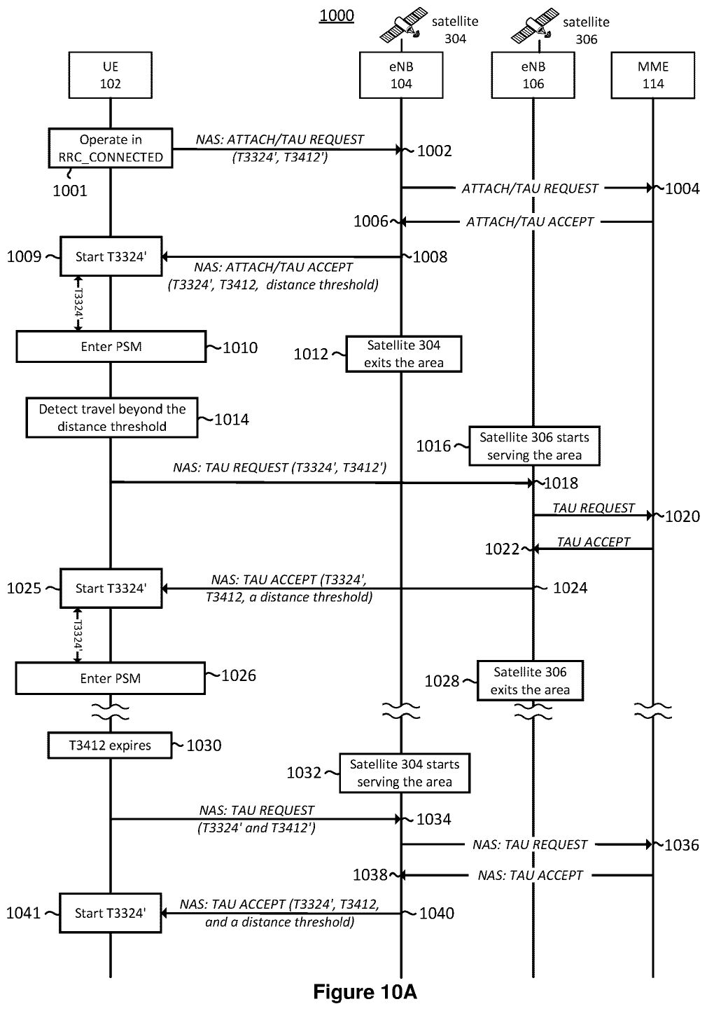

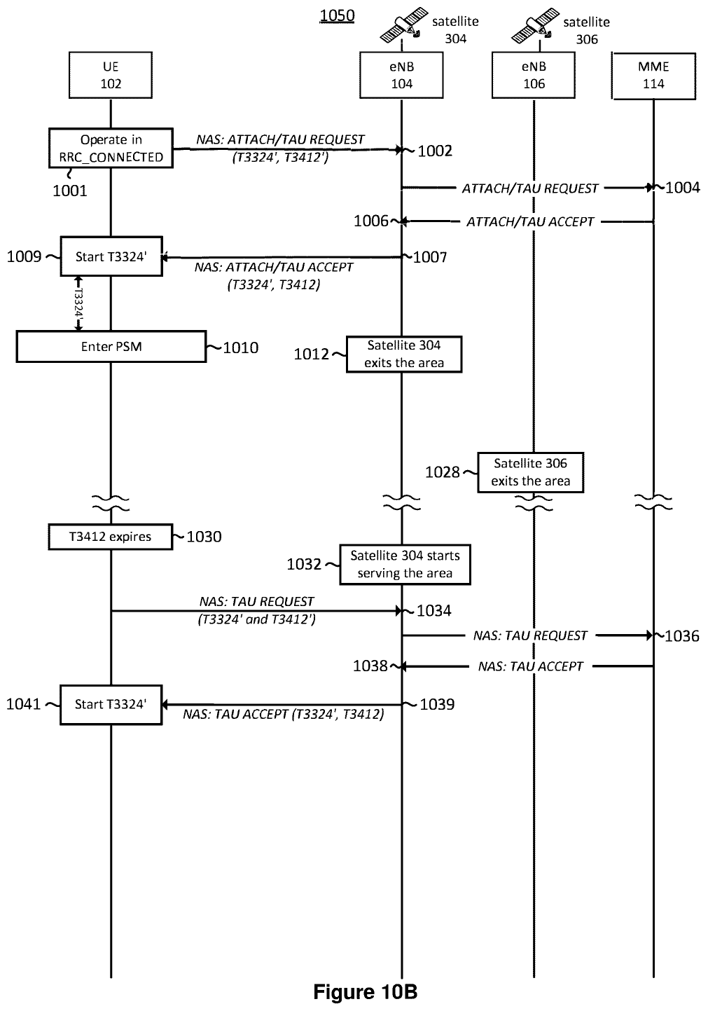

Next, FIG. 10A illustrates a messaging diagram of an example scenario 1000 in which a UE informs the network of its capability to estimate the satellite coverage in the Attach or in the Tracking Area Update procedure, for aligning the PSM configuration with a period of satellite coverage. Although the BS 104, 106 are shown to be eNB radio access technology satellites, the BS 104, 106 could be implemented as any type of satellites 304, 306 compliant with 4G, 5G, 6G, or future standards.

The UE 102 initially connects to the eNB 104 via a service link provided by the satellite 304 and operates 1001 in the RRC_CONNECTED state. In this scenario, the UE 102 is capable of estimating the periods when the UE 102 will be within the coverage of at least one satellite, and the periods when the UE 102 will not be covered by any satellite, based on the satellite ephemeris information (i.e., satellite constellation information) provided to or pre-installed in the UE 102 beforehand, the UE location information, and some other assistance information provided by the network, such as the cell/beam footprint size and/or the antenna panel tilt. Initially, the UE 102 transmits 1002 a NAS message such as an ATTACH REQUEST or a TAU REQUEST message to the eNB 104, and then the eNB 104 encapsulates the ATTACH REQUEST or the TAU REQUEST message in an S1-AP message such as the Initial UE Message and forwards 1004 it to the MME 114. When sending the ATTACH REQUEST or the TAU REQUEST message, the UE 102 may indicate in the message its support of extended periodic timer value (e.g., via the MS network feature support IE) and include a T3324 value and a T3412 extended value, which the UE 102 selects so that that the UE 102 will only be active (for monitoring paging, performing the TAU, etc.) during the periods when the UE 102 is within the coverage of at least one satellite. In one implementation, the UE 102 uses dedicated IEs defined specifically to convey T3324′ and/or T3412′ rather than using the Ies defined for conveying T3324 value and T3412 extended values, in the ATTACH REQUEST or the TAU REQUEST message, to deliver the calibrated T3324 and T3412 values.

As an alternative to the above implementation, the UE 102 can include the T3324 value IE and T3412 extended value IE in the ATTACH REQUEST or the TAU REQUEST message, to deliver the calibrated T3324 and T3412 values, and indicates to the MME 114 via an additional IE (e.g., a one-bit flag) that the UE determined the T3324 and T3412 values by estimating the periods of the satellite coverage (i.e., the T3324 and T3412 values have been calibrated).

In response to the ATTACH REQUEST or the TAU REQUEST message, the MME 114 encapsulates the ATTACH ACCEPT or the TAU ACCEPT message in the Initial UE Message and sends 1006 it to the eNB 104. The eNB 104 then forwards 1008 the ATTACH

ACCEPT or the TAU ACCEPT message to the UE 102. The MME 114 provides in the ATTACH ACCEPT or the TAU ACCEPT message the determined PSM configuration for the UE 102. In one implementation, the determined PSM configuration contains a T3412 extended value that “echoes” the T3412/T3412′ extended value contained in the ATTACH REQUEST or the TAU REQUEST message, and a T3324′ value that echoes the T3324/T3324′ value contained in the ATTACH REQUEST or the TAU REQUEST message. In other words, the MME 114 accepts the recommendation of the UE 102. The UE 102 then enters PSM upon expiration of T3324′, which starts immediately upon UE 102 receiving the PSM configuration from the network.

In some implementations, the MME 114 may include the original T3324 value IE instead of the T3324′ value IE in the PSM configuration. In one implementation, in addition to the PSM configuration, the MME 114 also provides a distance threshold in the ATTACH ACCEPT or the TAU ACCEPT message, which is used by the UE 102 to examine whether it needs to perform TAU according to the distance it has traveled. Alternative to the above implementation, the the eNB 104 broadcasts the above-mentioned distance threshold in a system information block.

After receiving the ATTACH ACCEPT or the TAU ACCEPT message, the UE 102 starts 1009 the T3324′ timer. Upon expiration of the T3324′ timer, the UE 102 transitions 1010 to the PSM and starts T3412. In some implementations, the UE 102 also starts an inactivity timer after receiving the ATTACH ACCEPT or the TAU ACCEPT message, and the UE 102 then transitions to the RRC_IDLE state before transitioning to the PSM upon the expiration of the inactivity timer. In other implementations, after receiving the ATTACH ACCEPT or the TAU ACCEPT message, the UE further receives an RRC Connection Release message from the eNB 104 via the satellite 304 and transitions to the RRC_IDLE state before transitioning to the PSM, in response to the RRC Connection Release message. If the UE 102 transitions to the RRC_IDLE state before transitioning to the PSM, the UE 102 starts T3412 upon transitioning to the RRC_IDLE state instead of upon transitioning in the PSM.

At a later time, the UE 102 in the PSM is no longer within the service area of the satellite 304, because the satellite 304 has moved 1012 to a new position that makes the satellite 304 unable to cover the UE 102. Afterward, the UE 102 detects 1014 that it has traveled a distance greater than the distance threshold provided by the MME 114 or by the eNB 104. When the UE 102 detects that the satellite 306 has started 1016 serving the area (i.e., has started covering the UE 102), the UE 102 performs the RRC connection setup procedure with eNB 106 and transmits 1018 the TAU REQUEST message to the eNB 106 to inform MME 114 of the updated UE location. The UE 102 may include an updated T3324/T3324′ value and an updated T3412/T3412′ extended value in the TAU REQUEST message, where the updated T3324/T3324′ value and the updated T3412/T3412′ extended value are determined by the UE 102 based on the new UE location information and the satellite ephemeris information. In one implementation, the UE 102 also includes an additional flag, IE, or other indicator in the TAU REQUEST message to indicate whether the UE estimated periods of satellite coverage to generate the T3324 and T3412 values.

The eNB 106 forwards 1020 the TAU REQUEST message to the MME 114 upon receiving the message from the UE 102, and then receives 1022 the TAU ACCEPT message from the MME 114 in response to the TAU REQUEST message. The TAU ACCEPT message may contain a T3412 extended value that echoes the T3412/T3412′ extended value transmitted in the TAU REQUEST message, a T3324′ value that echoes the T3324/T3324′ value transmitted in the TAU REQUEST message, and an updated distance threshold. The UE 102, upon receiving 1024 the TAU ACCEPT message, replaces the stored T3324′ value and T3412 extended value by the new values contained in the TAU ACCEPT message, and then starts 1025 the timer T3324′. Upon expiration of T3324′, the UE 102 enters 1026 PSM and starts T3412. In some cases, the UE 102 may transition into the RRC_IDLE state before entering PSM. In these cases, the UE 102 starts the T3412 timer earlier, when the UE 102 transitions to the RRC_IDLE state. Soon after the UE 102 transitions to the PSM, the satellite 306 moves 1028 to a new position that makes the satellite 306 unable to cover the UE 102.

After timer T3412 expires 1030, the UE 102 needs to perform periodic TAU with the MME 114. The UE 102 waits until the upcoming satellite (e.g., the satellite 304 connected to the eNB 104) starts 1032 serving the area where the UE 102 locates, and the UE 102 then transmits 1034 the TAU REQUEST to the MME 114 via the eNB 104. When sending the TAU REQUEST message, the UE 102 may indicate its support of extended periodic timer value (e.g., via the MS network feature support IE, for example) and include a T3324/T3324′ value and a T3412/T3412′ extended value, where the T3324/T3324′ value and the T3412/T3412′ extended value are determined by the UE 102 based on the UE location information and the satellite ephemeris information. The UE 102 may also include an additional indication in the TAU REQUEST message to indicate whether the included T3324 and T3412 values are based on the UE estimating or predicting periods of satellite coverage. The eNB 104 then forwards 1036 the TAU REQUEST message to the MME 114. In response to the TAU REQUEST message, the MME 114 transmits 1038 a TAU ACCEPT message to the UE 102 via the eNB 104. The message may contain a T3412 extended value that echoes the T3412/T3412′ extended value included in the TAU REQUEST message, a T3324′ value that echoes the T3324/T3324′ value included in the TAU REQUEST message, and an updated distance threshold. The UE 102, upon receiving 1040 the TAU ACCEPT message, replaces the stored T3324′ value and T3412 extended value by the new values contained in the TAU ACCEPT message, and then starts 1041 T3324′.

In one implementation, the MME 114 may transmit another instance of T3412 instead of the T3412 extended value IE in the ATTACH ACCEPT or in the TAU ACCEPT message. Upon receiving the ATTACH ACCEPT or the TAU ACCEPT message containing this T3412 instance, the UE 102 starts T3412 immediately rather than upon transitioning to the RRC_IDLE state or entering PSM. In one implementation, this T3412 instance has the same values or the same value range as the T3412 extended value IE.

FIG. 10B is a messaging diagram of another example scenario 1050 in which a UE informs the network of its capability to estimate the satellite coverage in the Attach or in the Tracking Area Update procedure, for aligning the PSM configuration with a period of satellite coverage. This scenario is generally similar to the scenario 1000, but here the UE 102 receives only timer values, and does not receive or utilize a distance threshold. The differences between scenarios 1000 and 1050 are discussed below.

When the eNB 104 then forwards 1007 the ATTACH ACCEPT or the TAU ACCEPT message to the UE 102, the message includes a PSM configuration that does not include a distance threshold, for the UE 102. In scenario 1050, UE 102 no longer detects whether the UE has traveled beyond the distance threshold (i.e., 1014 in scenario 1000 is absent in scenario 1050). Actions 1016, 1018, 1020, 1022, 1024, 1025, and 1026 are not illustrated in FIG. 10B because they are similar with the ones in scenario 1000 (except NAS message TAU ACCEPT 1024 no longer can include a distance threshold). Actions 1028, 1030, 1032, 1034, 1036, 1038, and 1041 proceed as in scenario 1000 in FIG. 10A, but the NAS message TAU ACCEPT sent 1039 from eNB 304 to UE 102 no longer include a distance threshold.

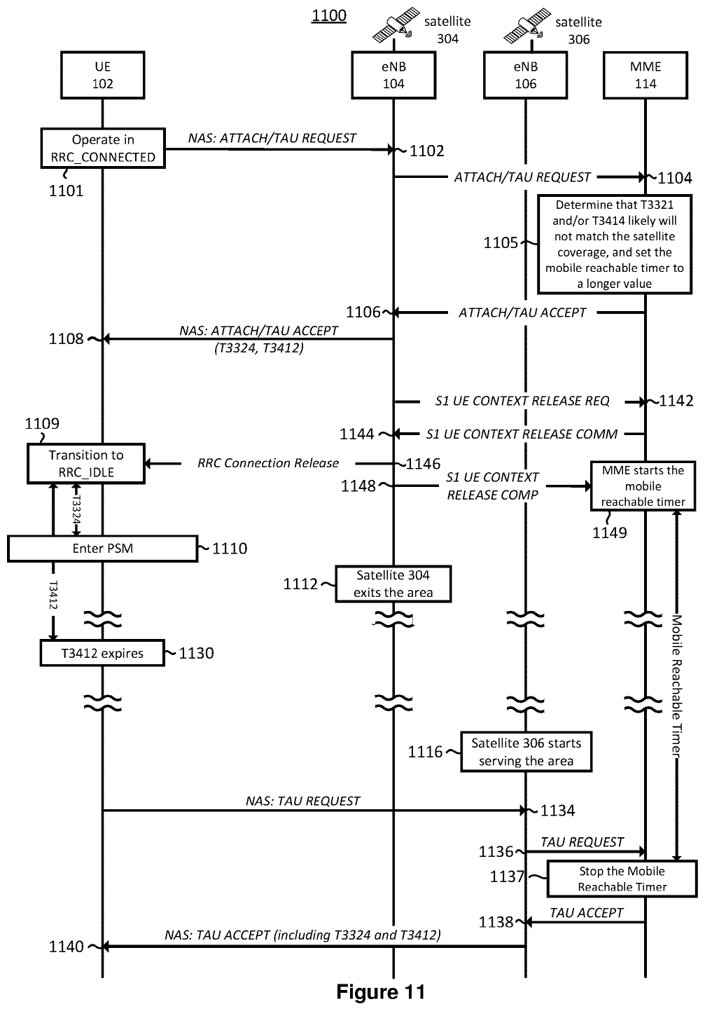

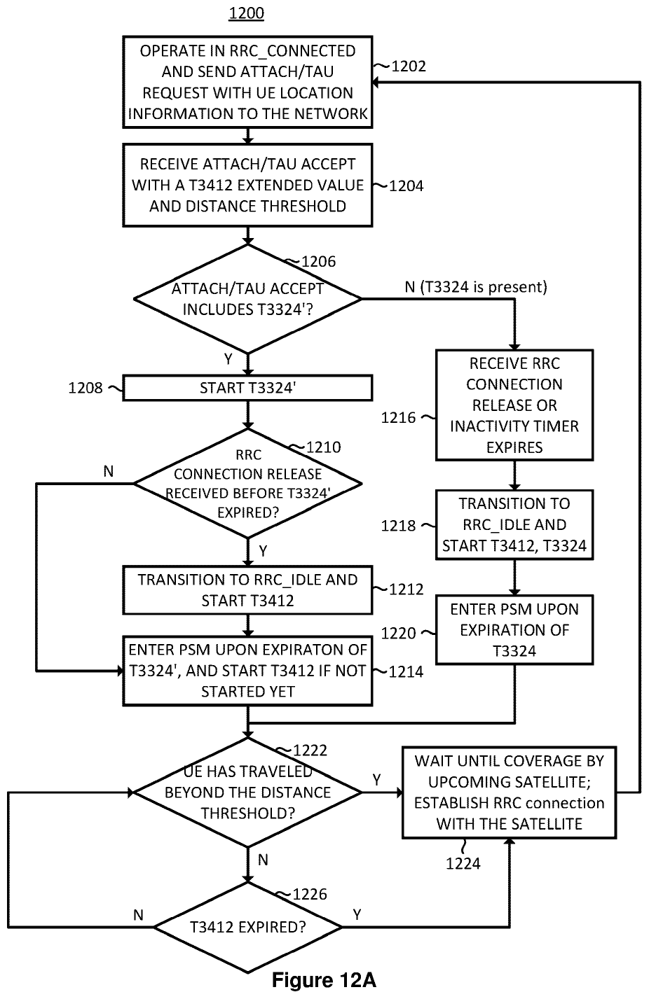

FIG. 11 is a messaging diagram of an example scenario in which the network extends the mobile reachable timer for the UE upon determining that the PSM configuration of the UE likely will not match the period of satellite coverage. The UE 102 initially connects to the eNB 104 via the service link associated with the satellite 304.

In this scenario, the UE 102 lacks the capability to estimate (determine, predict) the satellite coverage; nor is the UE 102 capable of providing the UE location information. The reasons for lacking this capability can be, for example, that the UE GNSS coordinate information is not available to the UE or is not sufficiently accurate, and/or that the satellite ephemeris information is not available to the UE or is not sufficiently accurate. Initially, the UE 102 operating 1101 in RRC_CONNECTED mode transmits 1102 a NAS message such as an ATTACH REQUEST or a TAU REQUEST message to the eNB 104. The eNB 104 then encapsulates the ATTACH REQUEST or the TAU REQUEST message in an SI-AP message such as the Initial UE Message, and forwards 1104 the message to the MME 114. When sending the ATTACH REQUEST or the TAU REQUEST message, the UE 102 may indicate in the message its support of extended periodic timer value (e.g., using MS network feature support IE, for example), and include a T3324 value and a T3412 extended value in the message. In one implementation, the UE indicates to the MME 114, via another IE, that the delivered T3324 and T3412 extended values are determined or selected without the UE estimating the periods of satellite coverage.

Upon receiving the ATTACH REQUEST or the TAU REQUEST, the MME 114 determines 1105 that it may not be able to provide the T3324 value and/or the T3412 extended value that makes the UE 102 only active (for monitoring paging, performing the TAU, etc.) during the periods when the UE 102 is within the coverage of at least one satellite, and in response associates the UE 102 with a mobile reachable timer that is longer than the typical setting for the timer. The typical or default setting of the mobile reachable timer can be 4 minutes greater than the T3412 extended value. In response to the ATTACH REQUEST or the TAU REQUEST message, the MME 114 encapsulates the ATTACH ACCEPT or the TAU ACCEPT message in the Initial UE Message and sends 1106 the message to the eNB 104. The eNB 104 then forwards 1108 the ATTACH ACCEPT or the TAU ACCEPT message to the UE 102. The MME 114 provides in the ATTACH ACCEPT or the TAU ACCEPT message the determined PSM configuration containing a T3412 extended value and a T3324 value for the UE 102.

The MME 114 may also include a distance threshold in the ATTACH ACCEPT or the TAU ACCEPT message, which the UE 102 can use to determine whether it needs to perform TAU according to the distance the UE 102 has traveled. As an alternative to the above implementation, the eNB 104 can broadcast the distance threshold in a system information block.

After sending 1108 the ATTACH ACCEPT or the TAU ACCEPT message, the eNB 104 starts an inactivity timer associated with the UE 102, and then sends 1142 the S1 UE CONTEXT RELEASE REQUEST message to the MME 114 upon expiration of the inactivity timer, for releasing the UE context stored at the MME 114. In response to the S1 UE CONTEXT RELEASE REQUEST message, the MME 114 replies 1144 the eNB 104 with the S1 UE CONTEXT RELEASE COMMAND message. In response to receiving the S1 UE CONTEXT RELEASE COMMAND message, the eNB 104 transmits 1146 the RRC Connection Release message to the UE 102, which makes the UE 102 transition 1109 to the RRC_IDLE state and start T3412 and T3324, accordingly. At the same time or soon after the eNB 104 transmits 1146 the RRC Connection Release message, the eNB 104 transmits 1148 the S1 UE CONTEXT RELEASE COMPLETE to the MME 114, which marks the completion of the UE context release procedure and triggers the MME 114 to start 1149 the mobile reachable timer.

The UE 102 enters 1110 PSM upon expiration of T3324, and the satellite 304 later exits 1112 the area where the UE 102 is located. Although the example in FIG. 11 illustrates the case where the UE 102 enters 1110 PSM before the satellite 304 exits 1112 the area, the order of these events in other cases can be reversed.

A relatively long time after the UE 102 enters PSM (and after the satellite 304 exited the area where the UE 102 is located), the timer T3412 expires 1130. The UE 102 at this time needs to perform periodic TAU with the MME 114 as soon as possible. The UE 102 waits until the upcoming satellite (e.g., the satellite 306 connected to the eNB 106 in this example) starts 1116 serving the area where the UE 102 is located and then transmits 1134 the TAU REQUEST to the MME 114 via the eNB 106.

When sending the TAU REQUEST message, the UE 102 may indicate in the message its support of extended periodic timer value (e.g., using the MS network feature support IE, for example) and include a T3324 value and a T3412 extended value in the message. In one implementation, the UE 102 notifies the MME 114, using a flag or another suitable IE, that the UE did not determine the values for T3324 and T3412 based on an estimate of future satellite coverage. The eNB 106 forwards 1136 the received TAU REQUEST message to the MME 114.

In this example, the MME 114 has associated 1105 the UE 102 with a sufficiently long mobile reachable timer. As a result, the mobile reachable timer has not expired, and the MME 114 still has the UE context for the UE 102, at the time when the MME 114 receives 1136 the TAU REQUEST message. The MME 114 can stop 1137 the mobile reachable timer and send 1138 to the eNB 106 the TAU ACCEPT message including a T3412 extended value and a T3324 value for the UE 102. The eNB 106 then forwards 1140 the received TAU ACCEPT message to the UE 102.

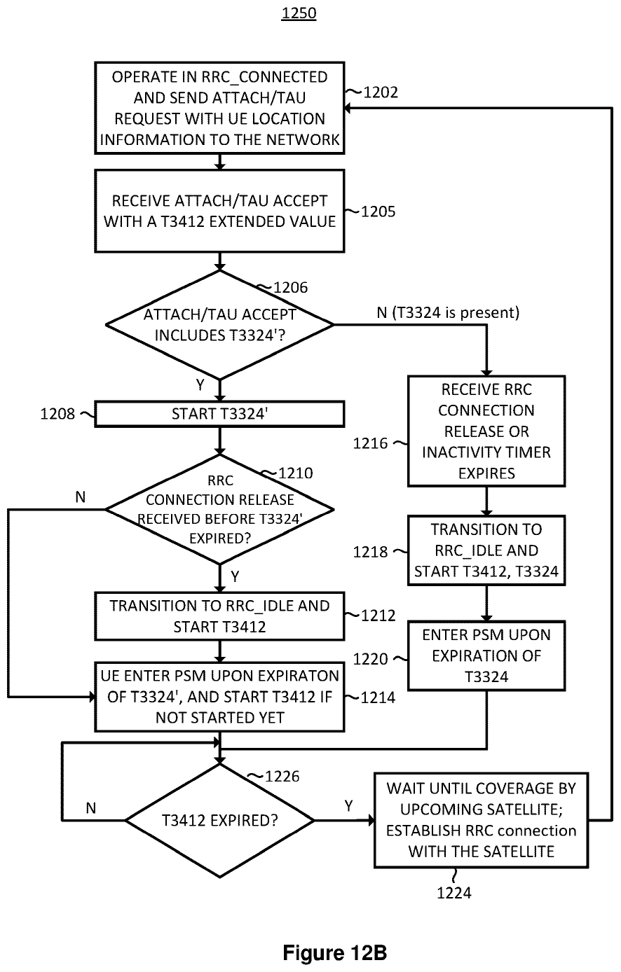

FIG. 12A is a flow diagram of an example method 1200 that can be implemented in a UE (e.g., UE 102 in this disclosure) capable of obtaining its location information (e.g., the GNSS coordinate). The method 1200 is for determining how to apply the PSM configuration and when to perform TAU in the PSM.

Initially, at block 1202, the UE has established an RRC connection with the eNB operating in NTN, and sends the ATTACH REQUEST or the TAU REQUEST message containing UE's location information to the network (i.e., the MME). The UE may also include a T3412 extended value and a T3324 value in the ATTACH REQUEST or the TAU REQUEST message. At block 1204, the RRC_CONNECTED UE receives the ATTACH ACCEPT or the TAU ACCEPT message containing a T3412 extended value and a distance threshold. The ATTACH ACCEPT or the TAU ACCEPT message may also contain a T3324 value or a T3324′ value. If, at block 1206, the UE determines that the ATTACH ACCEPT or the TAU ACCEPT message contains a (legacy) T3324 value, the flow proceeds to block 1216, where the UE waits until it receives the RRC Connection Release message from the network, or until its inactivity timer expires. Then the UE transitions to the RRC_IDLE state and monitors paging according to its DRX or eDRX configuration at block 1218. The UE also starts the timer T3324 and T3412 upon transitioning to the RRC_IDLE state at block 1218. Upon expiration of T3324, the UE transitions to the PSM at block 1220, and the flow proceeds to block 1222.

On the other hand, if the UE determines at block 1206 that the ATTACH ACCEPT or the TAU ACCEPT message contains a T3324′ value, the flow proceeds to block 1208, where the UE starts the timer T3324′ immediately upon receiving the ATTACH ACCEPT or the TAU ACCEPT message. The flow then proceeds to block 1210, and the UE checks which of the following events occurs earlier: a) the UE receives an RRC Connection Release message from the network, b) the inactivity timer expires, or c) the timer T3324′ expires. If the UE receives an RRC Connection Release message or the inactivity timer expires before the timer T3324′ expires, the flow proceeds to block 1212, where the UE starts the timer T3412, transitions to the RRC_IDLE state, and monitors paging according to its DRX or eDRX configuration. Upon expiration of T3324′, the UE transitions to PSM at block 1214. If the UE determines at block 1210 that the timer T3324′ expires before the UE receiving the RRC Connection Release message and before the inactivity timer expires, the flow proceeds to block 1214, where the UE transitions immediately through the RRC_IDLE state, enters PSM directly, and starts the timer T3412.

After entering PSM, the UE continuously or periodically checks whether it has traveled a distance that is greater than the distance threshold, and also checks whether T3412 has expired, at block 1222 and 1226. If either of the above is true, the flow proceeds to block 1224, where the UE waits until it is covered by the upcoming/next satellite, and then establishes the RRC connection with the eNB of the satellite, in order to perform the periodic TAU or to update the network with the latest UE location information, i.e., such that the transmitting of the TAU request is delayed until the UE has entered a coverage area of a radio access network (RAN) connected to the core network.

FIG. 12B is a flow diagram of an example method 1250 that is generally similar to the method 1200, but here the UE does not receive or use a distance threshold. The method 1250 includes block 1205 (rather than block 1204 of FIG. 12A), where the UE operating in the RRC_CONNECTED state receives the ATTACH ACCEPT or the TAU ACCEPT message containing a T3412 extended value, and no distance threshold. Further, the flow in the method 1250 proceeds from block 1214 directly to block 1226, because this method does not include checking whether the UE has exceeded a threshold, unlike block 1222 of FIG. 12A.

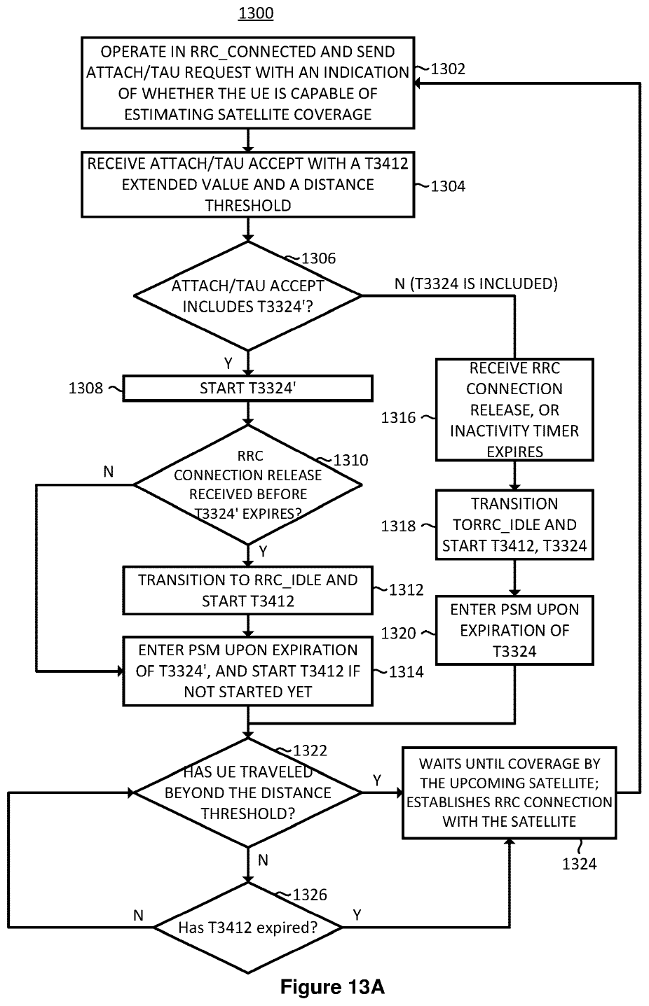

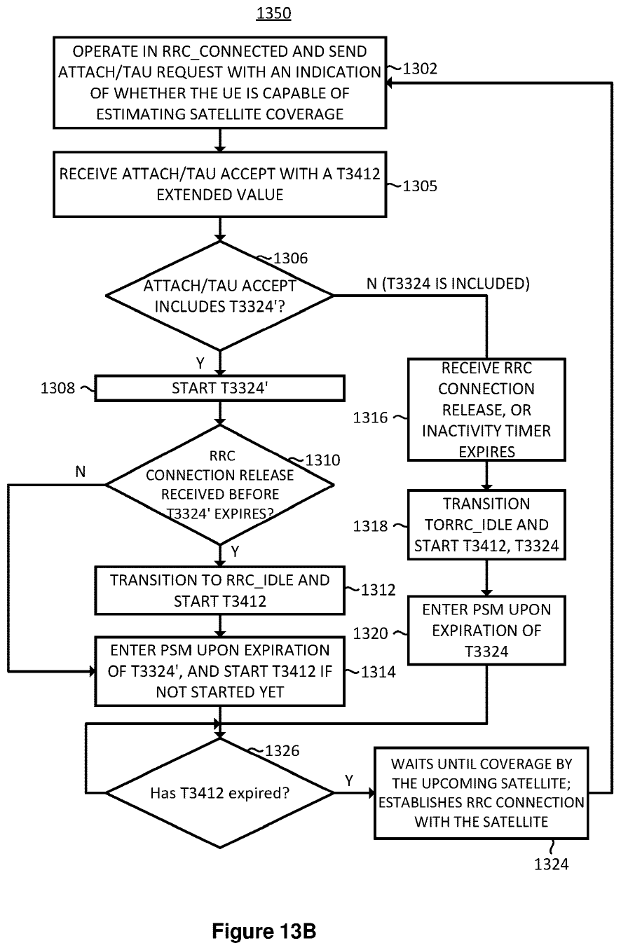

FIG. 13A is a flow diagram of an example method 1300 that can be implemented by a UE (e.g., UE 102 in this disclosure) capable of estimating/predicting the satellite coverage, for determining how to apply the PSM configuration and when to perform TAU in the PSM. Initially, at block 1302, the UE has established an RRC connection with the eNB operating in NTN, and sends the ATTACH REQUEST or the TAU REQUEST message containing the information implying or indicating whether the UE is able to estimate/predict the periods of the satellite coverage to the network (i.e., the MME). In one implementation, the UE includes an explicit indication in the ATTACH REQUEST or the TAU REQUEST message, for indicating whether the UE is able to estimate/predict the periods of the satellite coverage. In another implementation, the UE include T3324′ and/or T3412′ instead of T3324 and/or T3412 in the ATTACH REQUEST or the TAU REQUEST message to indicate the UE is able to estimate/predict the periods of the satellite coverage. After that, at block 1304, the RRC_CONNECTED UE receives the ATTACH ACCEPT or the TAU ACCEPT message containing a T3412 extended value and a distance threshold. The ATTACH ACCEPT or the TAU ACCEPT message may also contain a T3324 value or a T3324′ value. If the UE determines at block 1306 that the ATTACH ACCEPT or the TAU ACCEPT message contains a legacy T3324 value, the flow proceeds to block 1316, where the UE waits until it receives the RRC Connection Release message from the network, or until its inactivity timer expires. The UE then transitions to the RRC_IDLE state and monitors paging according to its DRX or eDRX configuration at block 1318. The UE also starts the timer T3324 and T3412 upon transitioning to the RRC_IDLE state at block 1318. Upon expiration of T3324, the UE transitions to the PSM at block 1320, and the flow proceeds to block 1322.

On the other hand, if the UE determines at block 1306 that the ATTACH ACCEPT or the TAU ACCEPT message contains a T3324′ value, the flow proceeds to block 1308, where the UE starts the timer T3324′ immediately upon receiving the ATTACH ACCEPT or the TAU ACCEPT message. The flow then proceeds to block 1310, and the UE checks which of the following events occurs earlier: a) UE receives an RRC Connection Release message from the network, b) the inactivity timer expires, and c) the timer T3324′ expires. If the UE receives an RRC Connection Release message or the inactivity timer expires before the timer T3324′ expires, the flow proceeds to block 1312, where the UE starts the timer T3412, transitions to the RRC_IDLE state, and monitors paging according to its DRX or eDRX configuration. Upon expiration of T3324′, the UE transitions to PSM at block 1314. If at block 1310, the timer T3324′ expires before the UE receiving the RRC Connection Release message and before the inactivity timer expires the flow proceeds to block 1314, where the UE skips the RRC_IDLE state, transitions to the PSM directly, and starts the timer T3412.

After entering PSM, the UE continuously or periodically checks whether it has traveled a distance that is greater than the distance threshold, and also checks whether T3412 has expired, at block 1322 and 1326. If either of the above is true, the flow proceeds to block 1324, where the UE waits until it is covered by the upcoming/next satellite, and then establishes the RRC connection with the eNB of the satellite, in order to perform the periodic TAU or to update the network with UE's latest location information.

FIG. 13B is a flow diagram of an example method 1350 that can be implemented by an UE (e.g., UE 102 in this disclosure) capable of estimating/predicting the satellite coverage, for determining how to apply the PSM configuration and when to perform TAU in the PSM. This method is generally similar to the method 1300 of FIG. 13A, but here the UE does not receive or use a distance threshold. The method 1350 includes block 1305 (rather than block 1304 of FIG. 13A), where the UE operating in the RRC_CONNECTED state receives the ATTACH ACCEPT or the TAU ACCEPT message containing a T3412 extended value, and no distance threshold. Further, the flow in the method 1350 proceeds from block 1314 directly to block 1326, because this method does not include checking whether the UE has exceeded a threshold, unlike block 1322 of FIG. 13A.

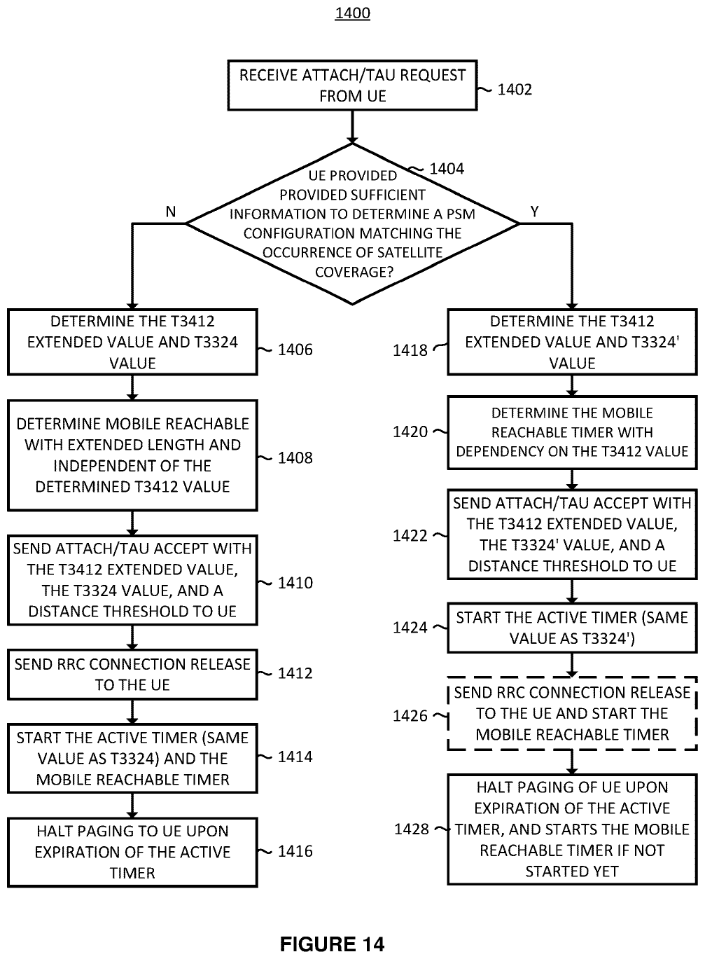

Next, FIG. 14 depicts a flow diagram of an example method 1400 that can be implemented in a network device or node (e.g., MME 114 in this disclosure) for determining a PSM configuration and a mobile reachable timer value for the UE (e.g., UE 102 in this disclosure). For convenience, the method 1400 is discussed below with reference to a single network device, but more generally the steps of the method 1400 can be distributed among any suitable number of network devices, e.g., an MME and one or more base stations.

Initially, at block 1402, the network device receives a TAU REQUEST or an ATTACH REQUEST message from the UE, and determines at block 1404 whether the information provided in the message is sufficient to generate a PSM configuration that matches the periods of satellite coverage for the UE. The above determination can be based, for example, on an explicit indication in the TAU REQUEST or the ATTACH REQUEST message of whether the UE is able to estimate/predict the periods of the satellite coverage, on whether the UE has provided its location information in the TAU REQUEST or the ATTACH REQUEST message, or on whether the UE has provided T3324′ and/or T3412′ instead of T3324 and/or T3412 in the TAU REQUEST or in the ATTACH REQUEST message. In one implementation, the network device determines that the information provided in the ATTACH/TAU REQUEST message is sufficient to configure the UE with the PSM configuration that matches the periods of the satellite coverage, if the ATTACH/TAU REQUEST message contains the explicit indication indicating the UE is able to predict/estimate the periods of the satellite coverage, and contains a T3324 value and/or a T3412 extended value. In one implementation, the network device determines that the information provided in the ATTACH/TAU REQUEST message is sufficient to configure the UE with a PSM configuration that matches the periods of the satellite coverage, if the ATTACH/TAU REQUEST message contains the UE location information, and if the network has the satellite ephemeris information. In one implementation, the network determines that the information provided in the ATTACH/TAU REQUEST message is sufficient to provide the UE with a PSM configuration that matches the periods of the satellite coverage if the ATTACH/TAU REQUEST message contains the T3324′ value and/or the T3412′ extended value instead of containing the T3324 value and/or the T3412 extended value.

If the network device determines, at block 1404, that the information is insufficient, the flow proceeds to block 1406, where the network device determines a T3412 extended value and a T3324 value for the UE. At block 1408, the network device determines a value for the UE mobile reachable timer that is independent of the determined T3412 extended value and is longer than its default setting (the conventional/default setting of the mobile reachable timer is 4 minutes greater than the T3412 extended value).

The network device then sends the ATTACH/TAU ACCEPT message containing the T3412 extended value, the T3324 value, and a distance threshold to UE, and starts an inactivity timer for the UE at block 1410. Upon expiration of the inactivity timer, the network device sends an RRC Connection Release message to the UE that transitions the UE to the RRC_IDLE state at block 1412. At the same time, the network starts the active timer that is identical to the T3324 value, and the mobile reachable timer for the UE at block 1414. Upon the expiry of the active timer, the network halts the paging to the UE even if there is a pending MT call/event, as shown in block 1416. Shortly after the expiry of the mobile reachable timer, the network may detach the UE from the network (i.e., release the UE context).

If the network device determines, at block 1404, that the information is sufficient, the flow proceeds to block 1418, where the network device determines a T3412 extended value and a T3324′ value for the UE, and then determines at block 1420 a mobile reachable timer value for the UE that has dependency on the T3412 extended value (e.g., the mobile reachable timer is 4 minutes greater than the T3412 extended value). At block 1422, the network device sends the ATTACH/TAU ACCEPT message containing the T3412 extended value, the T3324′ value, and a distance threshold to the UE.

Upon transmitting the ATTACH/TAU ACCEPT message, the network device starts at block 1424 an inactivity timer for the UE, and also starts the active timer for the UE that is identical to the T3324 value. If the inactivity timer expires before the active timer expires, the flow proceeds to block 1426, where the network device sends an RRC Connection Release message to the UE and starts the mobile reachable timer for the UE. If the active timer expires before the inactivity timer expires, the flow bypasses block 1426 and proceeds directly to block 1428, where the network device starts the mobile reachable timer for the UE, and halts the paging of the UE even if there is a pending MT call/event. Shortly after the expiration of the mobile reachable timer, the network may detach the UE from the network (i.e., release the UE context).

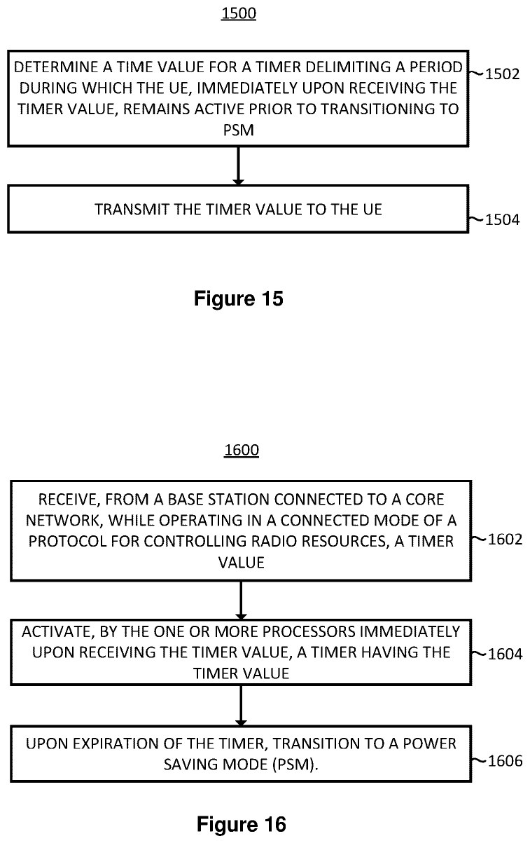

For further clarity, FIG. 15 depicts a flow diagram of an example method 1500 which can be implemented in a network device of this disclosure, or in multiple such devices (e.g., an MME and a base station). At block 1502, the network device determines timer value for a timer delimiting a period during which the UE, immediately upon receiving the timer value, remains active prior to transitioning to the PSM (blocks 1418). At block 1504, the network device transmits the timer value to the UE (events 908, 907, 1008, 1009).

FIG. 16 depicts a flow diagram of an example method 1600 which can be implemented in a UE of this disclosure. At block 1602, the UE operating in a connected mode of a protocol for controlling radio resources receives, from a base station connected to a core network, a timer value (events 908, 907, 1008, 1009; blocks 1204, 1205, 1304, 1305). At block 1604, the UE activates, immediately upon receiving the timer value, a timer having the timer value (events 909, 1009; blocks 1208, 1308). At block 1606, upon expiration of the timer, the UE transitions to PSM (events 910, 1010; blocks 1214, 1314).

According to any of the method discussed above, the UE can switch off its radio frequency (RF) receiver or make the RF receiver enter a lower power mode, before the UE determines that the UE is within coverage of the upcoming/next satellite. After the UE determines that the UE is within coverage of the upcoming/next satellite, the UE can switch on the RF receiver or make the RF receiver transition to a normal power mode. Upon switching on the RF receiver or making the RF receiver in the normal power mode, the UE receives and synchronizes DL signal(s) from the upcoming/next satellite and receive system information from the upcoming/next satellite using the RF receiver. After receiving the system information, the UE performs a random access procedure with the upcoming/next satellite to establish the RRC connection. In other implementations, the UE can make its NTN modem (i.e., RF receiver and baseband) enter a low power mode before the UE determines that the UE is within coverage of the upcoming/next satellite. After the UE determines that the UE is within coverage of the upcoming/next satellite, the UE can make the NTN modem transition to a normal mode. Upon making the NTN modem enter a normal mode, the UE receives and synchronizes DL signal(s) from the upcoming/next satellite and receives system information from the upcoming/next satellite using the NTN modem. After receiving the system information, the UE performs a random access procedure with the upcoming/next satellite to establish the RRC connection.

Although the examples above refer primarily to eNBs connected to satellites 304, 306, etc., these techniques also can be used in other types of base stations such as gNBs for example.

The following description may be applied to the description above.

Generally speaking, description for one of the above figures can apply to another of the above figures. Any event or block described above can be optional. For example, an event or block with dashed lines can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. The “eNB” can be replaced by “base station”, “gNB”, “6G base station”, “evolved gNB” or 6G gNB. The “ATTACH REQUEST” message and “ATTACH ACCEPT” message can be replaced by “REGISTRATION REQUEST” message and “REGISTRATION ACCEPT” message, respectively. “MME” can be replaced by AMF or evolved AMF or 6G AMF. “RRC Connection Release message” can be replaced by “RRC Release message”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

According to a first example, a method for configuring activation of a PSM in a UE is implemented in a network device. This method includes determining a timer value for a timer delimiting a period during which the UE, immediately upon receiving the timer value, remains active prior to transitioning to the PSM. The method further includes transmitting the timer value to the UE.

According to a second example, the method in the first example further includes determining a current location of the UE based on the current location of the UE.

A third example is the method of the second example in which the determining of the current location of the UE includes receiving an indication of the current location from the UE.

A fourth example is the method of the third example in which the indication of the current location is received via a TAU request message.

A fifth example is the method of the third example in which the indication of the current location is received via an attach message.

A sixth example is a method as in any of second to fifth example in which the current location of the UE corresponds to a set of geographic coordinates.

A seventh example is the method of any of the second to the fifth example in which the current location of the UE corresponds to a geographic region in which the UE currently operates.

An eight example is a method as in any of second to seventh example in which the determining of the timer value includes estimating future satellite coverage for the UE based on the current location of the UE and satellite ephemeris information.

A ninth example is the method of the first example in which the determining of the timer value includes: (1) receiving, from the UE, a currently configured timer value for a UE timer that delimits a period of time during which the UE operates in an idle mode prior to transitioning to the PSM, and (2) using the currently configured timer value to determine the timer value.

A tenth example is the method of the ninth example in which the UE timer is a T3324 timer.

An eleventh example is the method of the first example in which the determining of the timer value includes: (1) receiving a suggested timer value, and (2) setting the timer value to the suggested timer value.

A twelfth example is the method of the eleventh example in which the determining of the timer value further includes receiving an indication that the suggested timer value corresponds to the timer distinct from a T3324 timer.

A thirteenth example is the method of the twelfth example in which the determining of the timer value further includes receiving an indication that the UE is capable of estimating future satellite coverage.

A fourteenth example is the method of the first example in which the determining of the timer value further comprises: determining whether to calculate the timer value using a suggested timer value calculated at the UE based on at least one of: (i) an explicit indication that the UE is capable of estimating future satellite coverage, included in a message from the UE, (ii) presence of current location of the UE in the message from the UE, or (iii) presence of a suggested timer value in the message from the UE.

A fifteenth example is the method of any of the first to fourteenth examples, further including: (1) determining a second timer value for a second timer delimiting a period during which the UE remains in the PSM prior to waking up, and (2) transmitting, by the one or more processors to the UE, the second timer value.

A sixteenth example is the method of fifteenth example in which the period that the second timer delimits starts immediately after the UE receives the second timer value.

A seventeenth example is the method of fifteenth or sixteenth example in which the determining of the second timer value includes: (1) receiving a second suggested timer value for the second timer, and (2) setting the second timer value to the suggested second timer value.

An eighteenth example is the method of the seventeenth example in which the determining of the second timer value further includes receiving an indication that the suggested second timer value corresponds to the second timer distinct from a T3412 timer.

A nineteenth example is the method of any of the first to eighteenth example in which the network device operates in a core network and communicates with the UE via a non-terrestrial network (NTN).

A twentieth example is the method of any of the first to nineteenth example in which the transitioning to the PSM includes deactivating a radio frequency (RF) receiver or transitioning the RF receiver from a normal-power mode to a low-power mode.

A twenty-first example is the method of any of the first to nineteenth example in which the transitioning to the PSM includes lowering power consumption of the UE relative to operation in an RRC_IDLE state.

A twenty-second example is a method for configuring a PSM in a UE, the method being implemented in a core network. This method includes: (1) receiving, via a non-terrestrial network (NTN), a message from the UE; (2) determining that upon expiration of a timer set to an initial value delimiting a period during which the UE remains in the PSM prior to waking up, the UE will not have network coverage; (3) in response to the determining, generating, an extended timer value for the timer, the extended timer value being greater than the initial value; and (4) transmitting the extended timer value to the UE.

A twenty-third example is the method of the twenty-second example in which the receiving of the message from the UE includes receiving a TAU request message.

A twenty-fourth example is the method of the twenty-second example in which the receiving of the message from the UE includes receiving an attach message.

A twenty-fifth example is the method of twenty-third of twenty-fourth example, in which the message includes location information for the UE, and the method further includes generating the extended timer value is based on the location information.

A twenty-sixth example is the method of the twenty-fifth example in which the generating of the extended timer value is further based on satellite ephemeris information.

A twenty-seventh example the method of the twenty-second example in which the timer is a T3412 timer.

A twenty-eight example is the method of twenty-second to twenty-seventh example in which the transitioning to the PSM includes deactivating a radio frequency (RF) receiver or transitioning the RF receiver from a normal-power mode to a low-power mode.

A twenty-ninth example is the method of twenty-second to twenty-seventh example in which the transitioning to the PSM includes lowering power consumption of the UE relative to operation in an RRC_IDLE state.

A thirtieth example is a network device comprising one or more processors and configured to implement a method of any of the preceding examples.

A thirty-first example is a method for activating a PSM in a UE, the method being performed by the UE. This method includes (1) receiving a timer value, from a base station connected to a core network, while the UE operates in a connected mode of a protocol for controlling radio resources; (2) activating, immediately upon receiving the timer value, a timer having the timer value; and (3) upon expiration of the timer, transitioning to the PSM.

A thirty-second example is the method of thirty-first example further including prior to receiving the timer value, transmitting current UE location information to the core network.

A thirty-third example is the method of thirty-second example in which the transmitting of the current UE location information includes transmitting a TAU request message.

A thirty-fourth example is the method of thirty-second example in which the transmitting the current UE location information includes transmitting an attach message.

A thirty-fifth example is the method of any of thirty-first to thirty-fourth example in which the current UE location information corresponds to a set of geographic coordinates.

A thirty-sixth example is the method of any of thirty-first to thirty-fourth example in which the current UE location information corresponds to a geographic region in which the UE currently operates.

A thirty-seventh example is the method of any of thirty-first to thirty-sixth example further including: transmitting, to the core network and prior to receiving the timer value, a currently configured timer value for a UE timer that delimits a period of time during which the UE operates in an idle mode prior to transitioning to the PSM.

A thirty-eight example is the method of thirty-seventh example in which the UE timer is a T3324 timer.

A thirty-ninth example is the method of thirty-first example, further including: (1) estimating a future satellite coverage for the UE; (2) generating, based on the future satellite coverage, a suggested timer value for the timer; and (3) transmitting, to the core network and prior to receiving the timer value, the suggested timer value.

A fortieth example is the method of thirty-ninth example, further including transmitting, to the core network and prior to receiving the timer value, an indication that the UE is capable of estimating future satellite coverage.

A forty-first example is the method of any of thirty-first to fortieth example in which the base station operates in a non-terrestrial network (NTN).

A forty-second example is a UE including one or more processors and configured to implement a method of any of thirty-first to forty-first examples.

A forty-third example is a method for configuring activation of a PSM in a UE, the method being implemented in a network device. This method includes: (1) determining, using a current location of the UE, a timer value for a timer delimiting a period during which the UE remains active prior to transitioning to the PSM; and (2) transmitting, to the UE, the timer value.

A forty-fourth example is the method of forty-third example further including estimating network coverage for the UE based on the current location of the UE, the determining of the timer value being based on the estimated network coverage.

A forty-fifth example is the method of forty-fourth example in which the estimated network coverage is NTN coverage.

A forty-sixth example is the method of forty-third example in which the estimating of the network coverage for the UE uses satellite ephemeris information.

A forty-seventh example is the method of any of forty-third to forty-sixth example in which the timer is configured to start immediately after the UE receives the timer value.

1-18. (canceled)

19. A method performed by a network device of a core network, for configuring activation of a power saving mode, PSM, in a user equipment, UE, connected to the core network via a non-terrestrial network, NTN, the method comprising:
determining a timer value for a UE timer to measure a time interval during which the UE is to remain active before the UE transitions to the PSM, the time interval starting immediately after the UE receives the timer value; and
transmitting the timer value to the UE.

20. The method of claim 19, further comprising:
obtaining a current location of the UE,
wherein the determining of the timer value is based on the current location of the UE.

21. The method of claim 20, wherein the obtaining of the current location of the UE includes:
receiving, from the UE, a tracking area update, TAU, request message or an attach request message, the TAU request message or the attach request message including an indication of the current location.

22. The method of claim 20, wherein the determining of the timer value includes assessing the NTN coverage based on the current location of the UE and satellite ephemeris information.

23. The method of claim 19, further comprising:
receiving, from the UE, a currently configured timer value for the UE timer; and
using the currently configured timer value to determine the timer value.

24. The method of claim 19, wherein the determining of the timer value includes:
receiving, from the UE, a suggested timer value;
setting the timer value to the suggested timer value; and
receiving an indication that the UE is capable of estimating the NTN coverage.

25. The method of claim 19, further comprising:
determining a second timer value for a second timer delimiting a PSM period during which the UE remains in the PSM; and
transmitting the second timer value to the UE.

26. The method of claim 25, wherein the determining of the second timer value includes:
receiving, from the UE, a second suggested timer value;
if estimated the UE will be outside the NTN coverage when the second suggested timer expires, setting the second timer value to an extended timer value longer than the suggested second timer value.

27. The method of claim 26, further comprising:
obtaining location information for the UE; and
generating the extended timer value using the location information.

28. The method of claim 27, wherein the generating of the extended timer value further uses satellite ephemeris information.

29. A network device connected to a user equipment, UE via a non-terrestrial network, NTN, the network device comprising:
a processor configured to determine a timer value for a UE timer to measure a time interval during which the UE is to remain active before the UE transitions to the PSM, the time interval starting immediately after the UE receives the timer value;
a transceiver configured to transmit the timer value to the UE; and
a computer-readable storage media storing executable instructions for the processor to control the transceiver to transmit the timer value to the UE.

30. The network device of claim 29, the processor further configured to:
obtain a current location of the UE, wherein the timer value is based on the current location of the UE.

31. A method performed by a UE connected to a core network via a non-terrestrial network, NTN, for activating a power saving mode, PSM, the method comprising:
receiving, from the core network via the NTN, a timer value to measure a time interval during which the UE is to remain active before transitioning to the PSM;
activating a timer having the timer value immediately upon the receiving the timer value; and
upon expiration of the timer, transitioning to a power saving mode (PSM).

32. The method of claim 31, further comprising:
prior to receiving the timer value, transmitting current UE location information to the core network.

33. The method of claim 31, further comprising:
transmitting, to the core network via the NTN and prior to the receiving of the timer value, a currently configured timer value for a UE timer that delimits a period of time during which the UE operates in an idle mode prior to the transitioning to the PSM.

34. The method of claim 31, further comprising:
generating a suggested timer value using an estimated NTN coverage; transmitting, to the core network and prior to the receiving of the timer value, the suggested timer value and an indication that the UE is capable of estimating an NTN coverage.

35. A user equipment, UE, comprising:
a transceiver configured to receive, from the core network via the NTN, a timer value to measure a time interval during which the UE is to remain active before transitioning to the PSM;
a processor to activate a timer having the timer value immediately upon the receiving the timer value; and
a computer-readable storage media storing executable instructions for the processor,
wherein upon expiration of the timer, the processor is configured to transition the UE to a power saving mode (PSM).

36. The UE of claim 35, wherein prior to receiving the timer value, the processor controls the transceiver to transmit current UE location information to the core network.

37. The UE of claim 35, wherein the processor controls the transceiver to transmit, to the core network via the NTN and prior to the receiving of the timer value, a currently configured timer value for a UE timer that delimits a period of time during which the UE operates in an idle mode prior to the transitioning to the PSM.

38. The UE of claim 35, the processor further to:
generate a suggested timer value using an estimated NTN coverage; and
control the transceiver to transmit, to the core network and prior to the receiving of the timer value, the suggested timer value and an indication that the UE is capable of estimating an NTN coverage.
